(19) United States
(12) Patent Application Publication
(10) Pub. No.: US 2025/0277444 A1
(43) Pub. Date: Sep. 4, 2025

(54) SYSTEM AND METHOD FOR DEEP EARTH PENETRATING MULTI-STATIC GROUND MAPPING RADAR

(71) Applicant: CHAOS INDUSTRIES, INC., Hermosa Beach, CA (US)

(72) Inventors: Harry Bourne MARR, Jr., Manhattan Beach, CA (US); Eric William HANLEY, Hermosa Beach, CA (US); John Laurence DIFULVIO, III, Hermosa Beach, CA (US); Daniel THOMPSON, Hermosa Beach, CA (US)

(21) Appl. No.: 18/594,536

(22) Filed: Mar. 4, 2024

(51) Int. Cl. E21B 47/26; E21B 47/13; G01S 13/00; G01S 13/32

(52) U.S. Cl. CPC E21B 47/26; E21B 47/13; G01S 13/003; G01S 13/32

(57) ABSTRACT

Methods and systems are described herein for adaptive beamforming and ultra-low frequency GPR surveying using a time synchronized distributed sensor array system (“distributed system”). The distributed system may be a software-defined radio using multi-input-multi-output antenna elements. The distributed system includes multiple sensor nodes which are time synchronized using status information from a sensor node (e.g., timestamp of an occurrence of an event such as receipt of a request for local timestamp, a receipt of a calibration signal). The synchronized distributed system enables the generation of an adaptive beam profile that directs high-directionality beams toward desired targets (e.g., geological features, resource deposits, drill bits, etc.) while cohering the low-frequency signal to generate viable range resolutions and SNR at depths greater than 5000 meters. Further, the distributed system makes use of a scalable multistatic array to provide telecommunication and electromagnetic wave manipulation operations for applications of varying scale.

### BACKGROUND

Ground Penetrating Radar (GPR) systems facilitate the non-invasive investigation of subsurface features by employing high-frequency electromagnetic (EM) waves. Despite enjoying a remarkably broad range of possible applications, GPR systems are encumbered by inherent technical limitations that impede their operational efficacy.

The efficacy of GPR systems is contingent upon the electromagnetic properties of the subsurface medium, with variables such as moisture content, soil type, and temperature exerting a profound influence on wave propagation characteristics. These environmental factors can induce signal attenuation, dispersion, and scattering, further complicating data acquisition and analysis.

An additional hurdle GPR systems must overcome is balancing the inverse proportionality between the operational depth of GPR systems and the frequency of the EM waves employed. Thus, a trade-off between depth penetration and spatial resolution exists. High-frequency waves, while offering superior resolution, are attenuated more rapidly in conductive media, thus limiting their penetration depth. Conversely, low-frequency waves, capable of deeper subsurface penetration, suffer from diminished resolution, and are unable to provide high fidelity representations of closely spaced subsurface features. GPR systems are susceptible to interference from various sources, including radio frequencies, power lines, and other electromagnetic fields, which can introduce noise into the data. This noise can obscure or distort the radar signals, making it challenging to distinguish between the target signals and background clutter.

Seismic sounding techniques, which rely on the propagation of elastic waves through the Earth's subsurface to infer geological structures, share several limitations with GPR systems and further compound some of the processing issues GPR systems were developed to overcome.

The aforementioned shortcomings of current GPR and seismic sounding systems highlight the need for innovative solutions that can enhance depth penetration, improve resolution and clarity, reduce interference and noise, and mitigate the impact of environmental conditions.

### SUMMARY

Some implementations herein relate to a method. For example, method may include synchronizing, via a processor, data signals received or transmitted by a plurality of transceiver nodes based on status information shared by the plurality of transceiver nodes. Method may also include cohering, via the processor, synchronized data signals from the plurality of transceiver nodes to generate a geophysical profile for an area of interest. Other embodiments of this aspect include corresponding computer systems, apparatus, and computer programs recorded on one or more computer storage devices, each configured to perform the actions of the methods.

The described implementations may also include one or more of the following features. Method may include: receiving, via the processor, status information for the plurality of transceiver nodes; identifying, via the processor, at least one target within the geophysical profile; generating, via the processor, a target acquisition protocol based on target data, the status information, and the geophysical profile; directing, via the processor, the plurality of transceiver nodes to perform a cohered characterization operation to acquire cohered target data within the area of interest in accordance with the target acquisition protocol, where the plurality of transceiver nodes is configured into a multistatic radar array for the cohered characterization operation; and executing, via the processor, supplemental feature analysis based on the cohered target data and the geophysical profile. Implementations of the described techniques may include hardware, a method or process, or a computer tangible medium.

Some implementations herein relate to a method. For example, system may include one or more processors configured to: synchronize data signals received or transmitted by a plurality of transceiver nodes based on status information shared by the plurality of transceiver nodes; and cohere synchronized data signals from the plurality of transceiver nodes to generate a geophysical profile for an area of interest. Other embodiments of this aspect include corresponding computer systems, apparatus, and computer programs recorded on one or more computer storage devices, each configured to perform the actions of the methods.

The described implementations may also include one or more of the following features. System may include: the one or more processors further configured to: receive status information for the plurality of transceiver nodes; identify at least one target within the geophysical profile; generate a target acquisition protocol based on target data, the status information, and the geophysical profile; direct the plurality of transceiver nodes to perform a cohered characterization operation to acquire cohered target data within the area of interest in accordance with the target acquisition protocol, where the plurality of transceiver nodes is configured into a bistatic radar array for the cohered characterization operation; and execute supplemental feature analysis based on the cohered target data and the geophysical profile. Implementations of the described techniques may include hardware, a method or process, or a computer tangible medium.

Some implementations herein relate to a method. For example, non-transitory computer-readable medium may include one or more instructions that, when executed by one or more processors of a device, cause the device to: synchronize data signals received or transmitted by a plurality of transceiver nodes based on status information shared by the plurality of transceiver nodes; and cohere synchronized data signals from the plurality of transceiver nodes to generate a geophysical profile for an area of interest. Other embodiments of this aspect include corresponding computer systems, apparatus, and computer programs recorded on one or more computer storage devices, each configured to perform the actions of the methods.

The described implementations may also include one or more of the following features. Non-transitory computer-readable medium may include: receiving status information for the plurality of transceiver nodes; identifying at least one target within the geophysical profile; generating a target acquisition protocol based on target data, the status information, and the geophysical profile; directing the plurality of transceiver nodes to perform a cohered characterization operation to acquire cohered target data within the area of interest in accordance with the target acquisition protocol, where the plurality of transceiver nodes is configured into a bistatic radar array for the cohered characterization operation; and executing supplemental feature analysis based on the cohered target data and the geophysical profile. Implementations of the described techniques may include hardware, a method or process, or a computer tangible medium.

### BRIEF DESCRIPTION OF THE DRAWINGS

FIG. 1 shows a distributed GPR array system, consistent with various embodiments.

FIG. 2 is a block diagram of a sensor node of the distributed system of FIG. 1, consistent with various embodiments.

FIG. 3A shows an example of synchronizing the sensor nodes using a calibration signal from a sensor node of the distributed system of FIG. 1, consistent with various embodiments.

FIG. 3B shows a block diagram of the distributed system of FIG. 1 configured to function as a cohered multistatic array of sensor nodes and antenna elements, consistent with various embodiments.

FIG. 4A shows a flowchart of a method for deep earth penetrating multistatic ground mapping radar, consistent with various embodiments.

FIG. 4B shows a flowchart of a subprocess for generating a target acquisition protocol and executing supplemental feature analysis for deep earth penetrating multistatic ground mapping radar, consistent with various embodiments.

FIG. 5A is a first block diagram illustrating the GPR system generating an adaptive beam pattern to generate a geophysical profile for an area of interest with high-directionality beams, consistent with various embodiments.

FIG. 5B is a second block diagram illustrating the distributed system generating an adaptive beam pattern for geosteering a target drill bit with high-directionality beams, consistent with various embodiments.

FIG. 6 shows a flowchart of a method for generating the geophysical profile by cohering time aligned data signals from sensor nodes of the GPR system of FIG. 1, consistent with various embodiments.

FIG. 7 shows a block diagram of a process for subdividing the geophysical profile into a plurality of substrata layers, consistent with various embodiments.

FIG. 8 is a block diagram of a radar system for identifying a target in the area of interest implemented using the GPR system of FIG. 1, consistent with various embodiments.

### DETAILED DESCRIPTION

In the following description, for the purposes of explanation, numerous specific details are set forth in order to provide a thorough understanding of the embodiments of the invention. It will be appreciated, however, by those having skill in the art, that the embodiments of the invention may be practiced without these specific details or with an equivalent arrangement. In other cases, well-known structures and devices are shown in block diagram form to avoid unnecessarily obscuring the embodiments of the invention.

The disclosed concept relates to a system that leverages a software-defined radio (SDR) comprising a number of time aligned antenna nodes to provide a flexible multi-function radio frequency (RF) solution. For example, the system may provide surveying, communications, radar, and electronic intelligence (ELINT) capabilities in a rapidly deployable software-defined architecture. In some embodiments, the system leverages machine learning algorithms to enable a distributed ground penetrating radar (GPR) sensor array of SDR antenna elements to perform radio frequency (RF) surveys for subsurface target characterization and/or supplemental feature analysis. For example, the RF surveys may enable estimating subsurface target mineral resources and reserves of hydrocarbons, categorizing rare earth mineral deposits, discriminating reservoir rocks, detecting tectonic features, and characterizing drilling conditions. In some embodiments, the system may employ cohered beamforming techniques to facilitate deep earth penetrating (e.g., depths up to and beyond 5000 meters) surveys (e.g.,) to conduct supplemental feature analysis for characterization of the area of interest (e.g., estimating net pay thickness, porosity, and fluid type during prospecting). In some embodiments, the supplemental feature analysis includes vertical electrical soundings (VES, Schlumberger DC resistivity), transient electromagnetics (TEM), HF-UHF ground-penetrating radar (GPR), and Electromagnetic Investigation of the Sub-Surface (EISS).

In some embodiments, the distributed GPR sensor array may utilize ultra-low frequency RF waveforms (e.g., ranges from 0.1 Hz to 1 MHz, or 1 Hrz to 200 KHz) to mitigate signal attenuation. In further embodiments, the GPR system may be configured with bistatic and/or multistatic nodes that are large distances apart (e.g., 1000 meters or more) to enable phase difference of arrival (PDoA) techniques with very long baselines between nodes (e.g., 1000 to 10,000 meters) that take advantage of diverse angles of arrival AOA. As will be described in greater detail herein, the system coheres the data signals from the distributed GPR sensor nodes to tightly time synchronize these distant RF nodes to within a picosecond accuracy, and thereby give spatial depth resolution that are less than 1 meter.

As will be described in greater detail herein, embodiments of the system are able to determine and apply adaptively determined beamforming weight vectors to the data signal generated by each sensor node by taking a series of synchronized snapshots of the GPR sensor node array data. This adaptive weight determination and synchronization may enable RF survey data from the sensor nodes to be cohered into a high-gain signal where relevant frequency data exceeds background noise. In some embodiments the system uses non-linear transfer function techniques, to model impedance through the ground as a convolution of all the layers of the ground. For example, the system may characterize a three dimensional (3D) region beneath the area of interest as a plurality of substrata layers where the data signal from the GPS system includes a matrix representation of the signal response associated with of the plurality of substrata layers. Accordingly, the system is able to resolve and/or analyze geophysical data on a layer-by-layer basis rather than for the area of interest as a whole. This fine grain control enables the system to facilitate optimization of well placement and prediction of drilling conditions in exploration, and monitoring of changes in fluid saturation during production. Further, the system is able to reduce data processing overhead by removing unwanted layer and noise components from the data signal. Embodiments of the system may be designed to adapt to continuously changing geophysical conditions to appropriately employ the surveying techniques and geophysical modeling approaches used in mineral resource characterization and acquisition operations. The system's ability to rapidly adapt to the changing or unknown conditions is designed to leverage the integration of advanced technologies such as AI and machine learning. The system may leverage adaptive beamforming techniques to point high-gain directional beams throughout the area of interest. These beams can be arbitrarily steered in real time to characterize the composition of the plurality of substrata layers based on target resource parameters known a priori and/or gathered in real time. Further, being able to synchronize multiple antenna nodes provides a technical discriminator enabling the system to further distribute receiving elements and create largescale GPR arrays capable of leveraging PDoA techniques for geophysical and/or geological feature analysis. Geophysical and/or geological feature data may characterize at least one of hydrocarbon deposits, dielectric coefficients, rock structures, metal/mineral deposits, ground water reservoirs, geothermal regions, oil and gas traps, stratigraphic unconformity, faults, pinch-outs, facies change, dielectric coefficients, rock structure, and stratigraphy data. Further embodiments may employ, Direct current (DC), shallow transient electromagnetic (sTEM), and ground penetrating radar (GPR) measurements, time-domain TEM, frequency induct (FI), and magneto telluric (MT) soundings.

In some embodiments, the system employs a multistatic array where sensor nodes are chosen from the distributed GPR array based on the sounding application being performed. For example, the exploration depth and resolution length may be a function of the distance between sensor nodes and the number of sensor nodes employed in the sounding. By employing more sensor nodes, the system is able to increase the available samples of the data signal that are cohered and used to further increase the gain of the received data signals. This cohered sampling enables embodiments of the system to increase the resolution of low-frequency GPR signals such that the system is able to leverage the relatively low signal attenuation rate of low frequency signals in GPR-relevant materials while overcoming the traditionally low-resolution length of low frequency signals performing deep earth penetrating surveys.

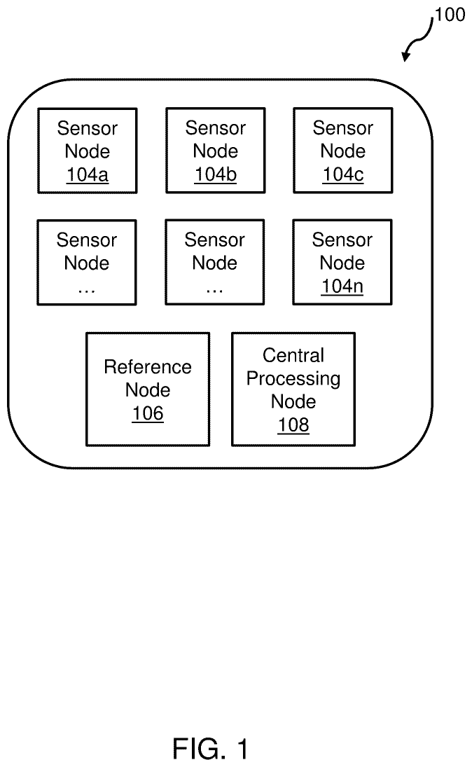

FIG. 1A shows a distributed sensor array system 100, consistent with various embodiments. For example, the distributed sensor array system (“distributed system”) 100 may include several sensor nodes 104a-104n that facilitate the transmission of waveforms as beams in a desired direction. In some embodiments, the distributed system 100 is a phased array system. The sensor nodes include the SDR that is configured to operate in a wide range of radio frequencies (e.g., 0.1 Hz to 200 KHz). The distributed system 100 may be implemented for various applications. For example, the distributed system 100 may be implemented in oil and gas industry for finding energy resources, in mining industry for finding metals, for surveillance as a radar system, a sonar system, etc. The following paragraphs describe the distributed GPR system 100 configured for transmission and reception of RF waveforms, but the distributed GPR system 100 is not limited to working with RF waveforms and may be configured to work with other waveforms as well (e.g., acoustic waves, seismic waves, etc.).

A sensor node may be configured to be one of (a) a transmit only sensor node in which case it may transmit waveforms but not receive waveforms, (b) a receive only sensor node in which case it may receive waveforms but not transmit waveforms, or (c) both transmit and receive sensor node in which case it may transmit or receive waveforms. Unless stated otherwise, a sensor node may be both a transmit and receive sensor node. Each of the sensor nodes 104a-104n may be configured to transmit an outgoing waveform (e.g., referred to as a “probe signal”) that may all combine together to form a beam in a particular direction. Each of the sensor nodes 104a-104n may receive a response to the probe signal (e.g., referred to as a “data signal”) that may be “time aligned” and cohered by the distributed system 100 for further processing (e.g., by a third-party system) for one or more applications.

The distributed system 100 time synchronizes the sensor nodes 104a-104n to time align the transmitted probe signals or the data signals received by the sensor nodes. In some embodiments, time aligning the data signals includes applying at least one of a time offset, phase, or amplitude to the data signals such that the data signals of all sensor nodes 104a-104n have the same time offset, phase and amplitude. The distributed system 100 may synchronize the sensor nodes 104a-104n in several ways. In one example, each sensor node may have a corresponding local clock (e.g., a quartz oscillator) and the local clock may be synchronized with a phase lock loop, which is synchronized with an external signal such as (a) an external clock signal that is wired to each receiver, or (b) a wireless external signal such as a GPS signal, an astrological signal (e.g., a quasar signal, the cosmic microwave background signals or other signals from radio astronomy), waveforms from television towers, acoustic waveform, or a calibration signal from a transmitter node in the distributed system 100. In another example, each sensor node's local clock may be made up of an atomic clock with a low drift (e.g., that may not drift more than a microsecond over the period of days or even months), where the atomic clock for each sensor node may be synchronized and aligned at the factory before the sensor nodes are deployed.

In some embodiments, each of the sensor nodes 104a-104n shares status information with the distributed system 100 (e.g., one or more other sensor nodes) such that any received signals or signals transmitted by the sensor nodes are calibrated and synchronized with each other to synchronize data collection across the distributed system 100. The status information may include a distance between sensor nodes, dielectric and/or resistivity information, and a desired depth, and sensor node availability. Further, the status information may include characterizations of material type and distribution, faulted high-velocity rocks with salt beds, heterogeneous depositional traps, thin reservoirs, pay thickness, porosity, saturation, pore space structure (rocks), salinity, temperature, fluid type, and a cementation exponent of the rock, and a tortuosity factor. In some embodiments, the status information may include high-density seismic, resistivity, and gravity surveys which detect traps, anticlines, stratigraphic unconformity, faults, pinch-outs, and facies change. Status information may further include terrain data, temperature in an environment of the sensor node; location (such as determined by GPS) of the sensor node; calibration metrics such as phase and amplitude offsets of the RF components (or optical components in the case of optics); or a timestamp of an occurrence of an event such as (a) a receipt of a signal (e.g., calibration signal, GPS signal, or any other known waveform) or (b) a receipt of a request for local timestamp of the sensor node. In some embodiments, the distributed system 100 synchronizes each of the sensor nodes 104a-104n with a reference node 106 of the distributed system 100 by computing a time offset between a timestamp of an occurrence of the event at a reference node 106 of the distributed system 100 and a timestamp of an occurrence of the event at the corresponding sensor node. For example, in the event the sensor nodes 104a-104n are implemented using factory-calibrated atomic clocks, a sensor node of the distributed system 100 (e.g., a central processing node 108) sends a request to each of the sensor nodes 104a-104n, including a reference node 106 of the distributed system 100, for a local timestamp of the corresponding sensor node and obtains a response including the local timestamp (e.g., a time at which the request is received at the corresponding sensor node). The distributed system 100 synchronizes a first sensor node 104a with the reference node 106 by computing a time offset between a reference timestamp of the reference node 106 and a first timestamp of the first sensor node 104a.

In another example where the distributed system 100 is configured to synchronize the sensor nodes 104a-104n using a calibration signal, the distributed system 100 synchronizes each of the sensor nodes 104a-104n with a reference node 106 of the distributed system 100 by computing a time offset between a timestamp of a receipt of a calibration signal at a reference node 106 of the distributed system 100 and a timestamp of receipt of the calibration signal at the corresponding sensor node. For example, the distributed system 100 synchronizes a first sensor node 104a with the reference node 106 by computing a time offset between a timestamp of a receipt of a calibration signal at the reference node 106 and a first timestamp of receipt of the calibration signal at the first sensor node 104a.

When a probe signal is transmitted or a data signal is received by the sensor nodes 104a-104n, the distributed system 100 (e.g., a central processing node 108) may apply the corresponding time offsets to the probe signals or the data signals of the sensor nodes 104a-104n to generate time aligned data signals for each of the sensor nodes 104a-104n.

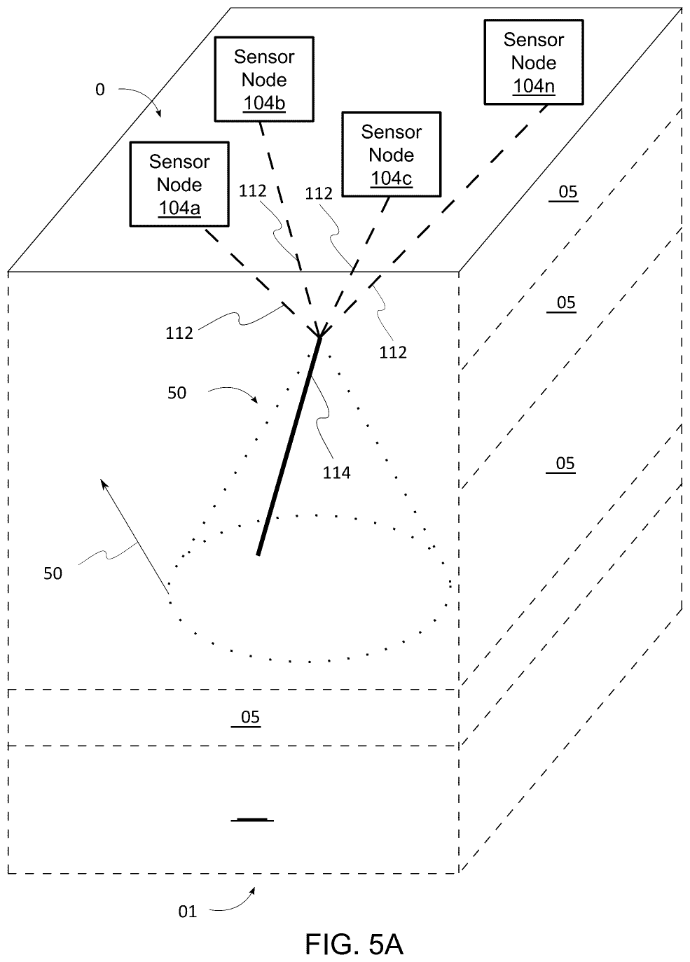

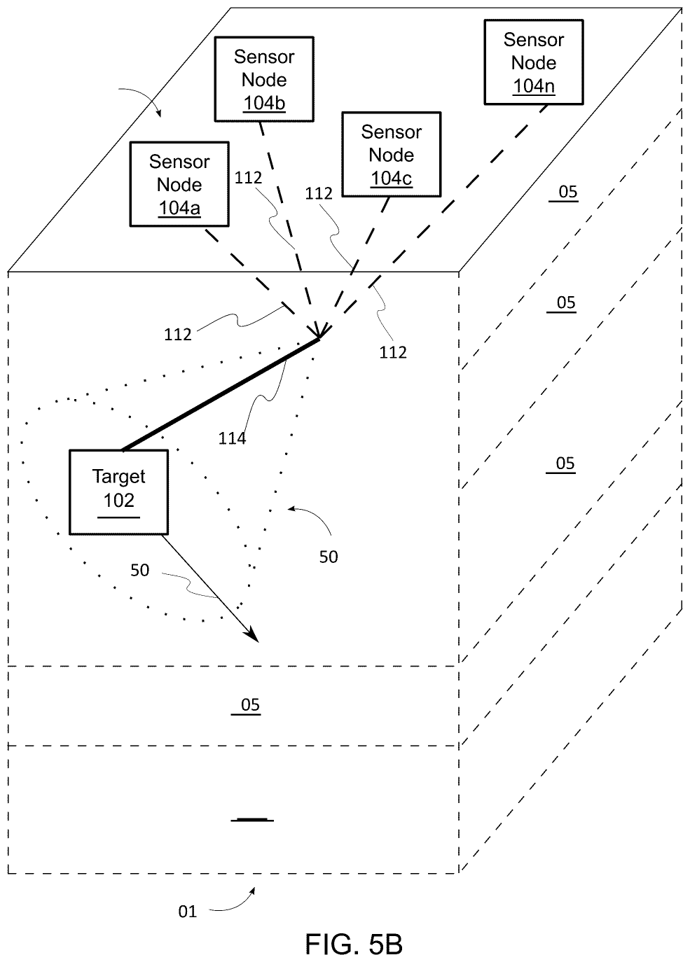

After the data signals are time aligned, the distributed system 100 coheres the time aligned data signals to generate a combined data signal with a coherent gain such that power level of the combined signal may be a function of the individual time aligned signals being combined. For example, the power level of the cohered signal is a sum of the power levels of the individual time aligned signals of the different sensor nodes 104a-104n. In another example, the power level of the cohered signal is greater than the power levels of any of the individual time aligned signals of the different sensor nodes. In some embodiments, the data signals are cohered by adding the time domain signals together from the different sensor nodes 104a-104n such that the data signals are time aligned and coherently added together. The cohered signal may then be intelligently signal processed by the distributed system 100, or provided to a third-party system, for one or more applications. One such application may include a mineral resource characterization and acquisition operation, such as a GPR survey system to determine one or more geophysical parameters (e.g., traps, stratigraphic unconformity, faults) in an environment of the distributed system 100. Another application may include detection of radar pulses. Another application may include digital receive beamforming to facilitate the creation of large, dispersed, and synchronized GPR arrays. In some embodiments, status information may be further processed, filtered, cohered, and analyzed to generate the geophysical profile. For example, once cohered, the status information may be used to generate a geophysical profile 501 (FIG. 5A) that highlights collections of hydrocarbons in at least one of the plurality of substrata layers 505 (FIG. 5A). The system may execute supplemental feature analysis to refine the geophysical profile 501 such that only hydrocarbon deposits exceeding a threshold volume and above a threshold depth are shown.

In some embodiments, one of the sensor nodes 104a-104n is designated as a reference node 106, whose clock acts as a reference clock for synchronizing the clocks of the other sensor nodes 104a-104n. In some embodiments, a central processing node 108 is one of the sensor nodes 104a-104n that is configured to perform various types of processing, such as computing time offsets, generating time aligned data signals, cohering time aligned data signals, etc. In some embodiments, the central processing node 108 and the reference node 106 are the same sensor node. In further embodiments, each individual sensor node is able to perform the requisite processing and coordination operations of the central processing node 108. Further, while descriptions included herein reference the operations (e.g., time synchronization) being performed by a single sensor node, such as the central processing node 108, the operations may be performed by another sensor node, such as the reference node 106, or by more than one sensor node. For example, any number of sensor nodes may perform the time synchronization or time alignment of data signals in the case where processing is done in a distributed way. Furthermore, time synchronization operations can be performed on a scheduled basis, prior to transmitting a probe signal, or prior to receiving the data signal.

In some embodiments, the sensor nodes 104a-104n may operate independent of each other, may not be physically connected to one another as they can communicate with other entities of the distributed system 100 wirelessly, which enables the distributed system 100 to be not only easily scalable but also to be configured to operate at low frequencies for ultra-deep RF signal penetration, minimal ground-based attenuation, and high-speed detection while enabling distance between sensor nodes 104a-104n to be application-specific (e.g., a nonuniform distribution of nodes, 1000 meters between nodes, more than 10 Km between nodes). The conventional phased array systems would have been very large or infeasible to implement for low-frequency operations as the size of the antenna is inversely proportional to the transmission/reception frequency, and the circuit boards that would house such antennas would be significantly large that is either difficult or infeasible to manufacture. In the distributed system 100, the sensor nodes 104a-104n can be spaced λ/2 (where λ is wavelength of the signal) distance units apart from each other. For example, if the frequency of the waveform transmitted by the sensor nodes 104a-104n is 50 MHz, which corresponds to a wavelength of approximately six meters, the sensor nodes 104a-104n may be placed approximately three meters apart from each other.

The sensor nodes 104a-104n, including the reference node 106 and the central processing node 108, may be co-located (e.g., located within a specified number of wavelengths of the operating frequency) or may be remotely located (e.g., located beyond the specified number of wavelengths of the operating frequency). For example, the first sensor node 104a and the second sensor node 104b may be co-located, while the reference node 106 may be remotely located. In another example, the first sensor node 104a and the second sensor node 104b may be co-located, while a third sensor node 104c may be remotely located. Regardless of how the sensor nodes 104a-104n are located, the sensor nodes 104a-104n may be synchronized as long as the location information of the sensor nodes 104a-104n, the reference node 106 or the central processing node 108 is available. For example, as mentioned above, the sensor nodes 104a-104n may have the capability to self-organize (e.g., share location information such as latitude, longitude, and elevation via the status information) or self-calibrate (e.g., synchronize themselves to the reference node 106). The distributed system 100 may have location information of the reference node 106 and sensor nodes 104a-104n that may be used in determining a time difference in arrival of the calibration signal at the sensor nodes with respect to the reference node 106, which may be further used in determining the time offset between the sensor nodes 104a-104n and the reference node 106. The sensor nodes may self-calibrate using the factory-calibrated atomic clocks, the calibration signal, or other known waveforms on a scheduled basis, prior to transmitting a probe signal, or prior to receiving a response to the probe signal.

The distributed system 100 may be easily scaled up or scaled down by adding or removing sensor nodes, respectively. Furthermore, since each sensor node 104a-104n may communicate with the reference node 106 or the central processing node 108 directly, all the sensor nodes 104a-104n are a single hop away from the reference node 106 or the central processing node 108, and any scaling of the distributed system 100 may not result in degradation of the time synchronization accuracy. In some embodiments, by having the sensor nodes distributed widely in space, interferometry data between the sensor nodes may be calculated and increased angle accuracy may be obtained even at low frequencies.

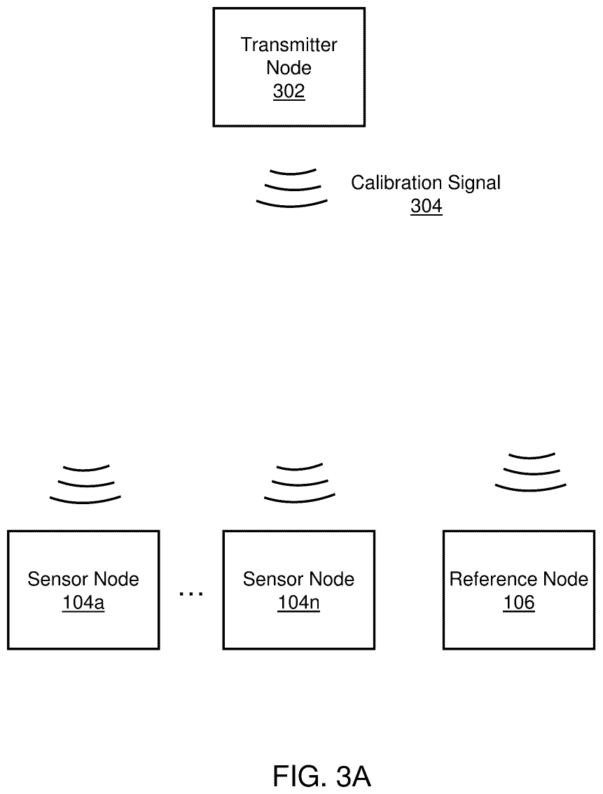

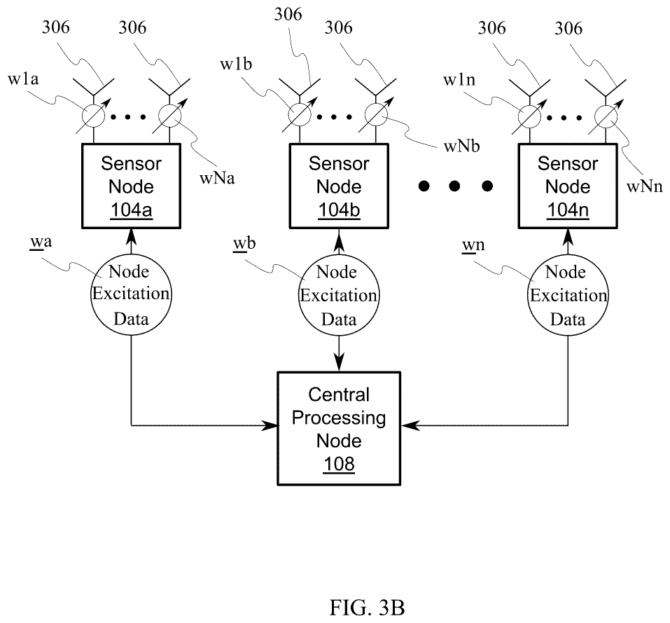

While FIG. 1 shows a single cluster of sensor nodes 104a-104n, the distributed system 100 may have several clusters in which each cluster may have several sensor nodes. Different clusters may have different number of sensor nodes or the same number of sensor nodes. In some embodiments, such a configuration facilitates determining the amount of in-place oil and gas resources in a prospect, contingent recoverable reserves during exploration, value of information (VOI) to be returned from the survey, and expected monetary value (EMV) from any identified resources; better angle resolution than available with a single cluster. Yet another advantage of having multiple clusters may be that one cluster could be significantly closer in distance to the received signal and suffer much less free space path loss of the signal and thus, get a much stronger signal to share between nodes. In some embodiments, the clusters may be spread over a few hundred meters or distributed throughout a massive geographic region. Each cluster may generate a cohered signal from the time aligned signals of its constituent sensor nodes and the cohered signal from all the clusters may be further cohered to generate a master cohered signal with a coherent gain such that the power level of the master cohered signal is a function of the power levels of the constituent cohered signals of the different clusters (FIG. 3B). For example, the power level of the master cohered signal is a sum of the power levels of the constituent cohered signals of the different clusters. In another example, the power level of the master cohered signal is greater than the power levels of any of the constituent cohered signals of the different clusters.

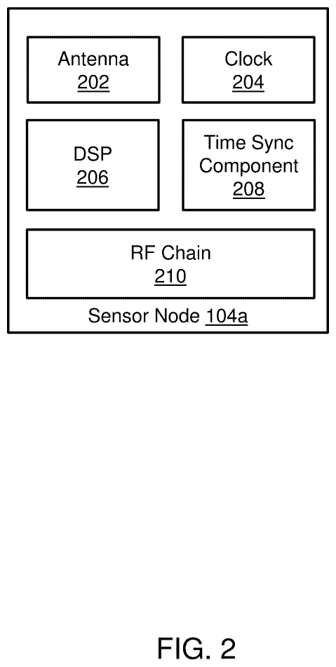

FIG. 2 is a block diagram of a sensor node of a distributed system of FIG. 1, consistent with various embodiments. A sensor node (e.g., first sensor node 104a) includes an antenna 202 that facilitates radiation or reception of waveforms when connected to a transmitter or receiver (not illustrated). The antenna 202 may be configured to transmit or receive waveforms of a wide range of frequencies. The first sensor node 104a may include a clock 204 that generates a clock signal for use in synchronizing the operations (e.g., coordinate sequence of actions) of the first sensor node 104a. The clock 204 may be a quartz clock, an atomic clock, or another type of clock.

The first sensor node 104a-104n may include a time synchronization component 208 that synchronizes the clock 204 of the first sensor node 104a in any of a number of ways mentioned above. For example, the time synchronization component 208 synchronizes the clock 204 with an external signal such as an external clock signal that is wired to the first sensor node 104a or a wireless external signal such as a GPS signal or an astrological signal. In another example, the time synchronization component 208 synchronizes the clock 204 to a clock of the reference node 106 using a calibration signal from a transmitter node (additional details of which are described at least with reference to FIGS. 3-5 below).

The first sensor node 104a includes a digital signal processor (DSP) 206 that is configured to perform various signal processing operations including generating time aligned signals, match filtering received calibration signals or data signals, setting a frequency range of the first sensor node 104a, radar signal processing, etc.

The first sensor node 104a includes an RF chain 210. In some embodiments, the RF chain 210 may be a cascade of electronic components and sub-units which may include any of amplifiers, filters, mixers, attenuators, and detectors. All these components may be combined to serve a specific application (e.g., a radar system for detection of target resource parameters within the plurality of substrata layers 505 (FIG. 5A) or geosteering a target 102 drill bit or downhole assembly). One or more of the components (e.g., the DSP 206 and time synchronization component 208) may be implemented using an SDR. The SDR facilitates various functionalities. For example, the SDR may facilitate obtaining of location information of the sensor nodes 104a-104n, the reference node 106, or the central processing node 108 (e.g., using a GPS). In another example, the SDR may facilitate in the generation of time aligned data signals.

Note that one or more components of the first sensor node 104a may be communicatively coupled to another device of the distributed system 100 via a communication module to coordinate its operations. Some or all of the components of the first sensor node 104a may be combined as one component. A single component may also be divided into sub-components, each sub-component performing a separate method step or method steps of the single component. Any one or more of the components described herein may be implemented using hardware (e.g., a processor of a machine) or a combination of hardware and software. For example, any component described herein may configure a processor 108 to perform the operations described herein for that component. Note that as used herein, processor 108 and central processing node 108 are used interchangeably to indicate the same processing portions of system 100.

FIG. 3A shows an example of synchronizing the sensor nodes 104a-104n using a calibration signal 304 from a transmitter node 302 of the distributed system 100. The calibration signal 304 may be any of a wide range of frequencies (e.g., 50 MHz, 144 MHz, 30 GHz, etc.). Because the time synchronization is not limited to being performed using a calibration signal, it can be performed in a number of ways as mentioned above at least with reference to FIG. 1. For example, the sensor nodes 104a-104n may be time synchronized using an external wireless signal such as a calibration signal 304 that is of a known waveform, such as a GPS signal, an astrological signal, seismic signal, acoustic signal, a signal transmitted from a transmitter (e.g., signal from television towers), or a signal transmitted from a transmitter node of the distributed system 100. In another example, time synchronization may be achieved by using factory-calibrated atomic clocks in the sensor nodes 104a-104n.

FIG. 3A is a block diagram of time synchronization of sensor nodes in the distributed system of FIG. 1, consistent with various embodiments. The transmitter node 302 may be co-located with the sensor nodes 104a-104n or may be remotely located. In some embodiments, the transmitter node 302 is considered to be co-located with the sensor nodes 104a-104n if the transmitter node 302 is within a specified proximity (e.g., a specified number of wavelengths of the calibration signal 304) of the sensor nodes 104a-104n. For example, if the transmitter node 302 frequency of transmission is 144 MHz, then the transmitter node 302 is considered to co-located with the sensor nodes 104a-104n if it is within “20”-“50” meters of any of the sensor nodes 104a-104n. If the transmitter node 302 is beyond the specified proximity (e.g., beyond 50m for 144 MHz frequency) of the sensor nodes 104a-104n, then the transmitter node 302 is considered to be remotely located. In some embodiments, the transmitter node 302 can even be located beyond the horizon in the case where the transmitter is quite powerful (e.g., hundreds or thousands of watts per transmit power amp with multiple transmit antennas that create a transmit phased array, and where the transmit frequency is at 50 MHz). Further yet, the transmitter node 302 may also be configured to be mobile, in motion or moving. in some embodiments, each of the plurality of transceiver nodes 104a-104n are wirelessly coherent and wirelessly coupled to form a multistatic phased array.

Regardless of whether the transmitter node 302 is co-located or remotely located, the transmitter node 302 is located in a known location relative to the sensor nodes 104a-104n, and the calibration signal 304 may be “seen” (e.g., calibration signal 304 is above the noise) or received by the sensor nodes 104a-104n without the need for signal processing. For example, the distributed system 100 may know the location information (e.g., latitude, longitude information) of the transmitter node 302. Such a configuration provides the flexibility of having the transmitter node 302 at any of various locations, and also eliminates the need for the sensor nodes 104a-104n to be in line of sight with each other.

Each of the sensor nodes 104a-104n, including the reference node 106, receives the calibration signal 304 and determines a timestamp of the receipt of the calibration signal 304. The distributed system 100 computes the time offsets of the sensor nodes 104a-104n based on the timestamps of the sensor nodes 104a-104n and the timestamp of the reference node 106 to synchronize the sensor nodes 104a-104n with respect to the reference node 106.

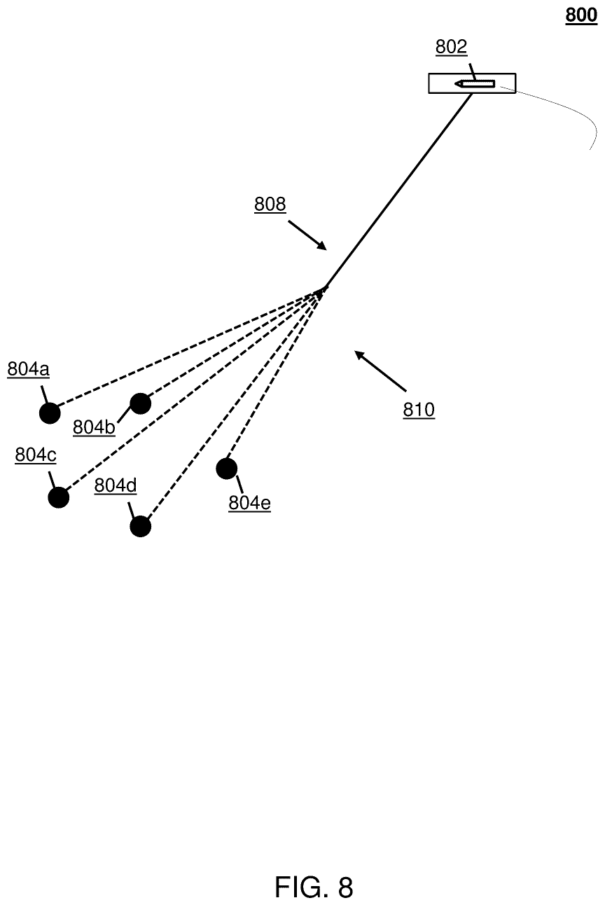

FIG. 3B is a block diagram of an embodiment of the distributed system 100 where each sensor node 104a-104n may be a modular accumulator that includes a plurality of antenna elements 306 (e.g., a plurality of isotropic antennas). The central processing node 108 may cohere the data signals and node excitation data wa-wn for each of the sensor nodes 104a-104n. The node excitation data wa-wn may include a matrix comprising a weight vector representation (e.g., w1a-wNa, w1b-wNb, w1n-wNn) for each of the plurality of antenna elements 306. Prior to or simultaneous with the cohering, the central processing node 108 may combine the node excitation data wa-wn for the nodes 104a-104b into a weight vector representation W. Because the sensor nodes 104a-104n may function as an SDR, the weight vector W may be tuned to produce a desired beam output from each of the sensor nodes 104a-104n. In some embodiments, the central processing node 108 dynamically tunes the weight vector W to produce an adaptive beam pattern 114 (see FIG. 5A or 5B described below) that may include at least one high directionality beam 114 (FIG. 5A) designed to scan the area of interest (FIG. 5A) or guide a target 102 drill bit during boring operations (FIG. 5B). In some embodiments, the at least one adaptive beam pattern 114 may include a plurality of read beams (e.g., probe signal 808 (see FIG. 8 described below), and/or data signal 810 (see FIG. 8 described below) disposed in a desired spatial configuration within an area of interest 502 (FIG. 5A), where each read beam is associated with a corresponding weight vector. Further, weight vector W may be tuned to steer any arbitrary beam within the adaptive beam pattern 114 as desired. In some embodiments, the distributed system 100 is a three-dimensional nonuniform array where a direction vector of the nonuniform array is cohered, via the processor 108, by multiplying a direction vector for each element 104a-104n of the nonuniform array (system 100) with a reference signal, wherein the reference signal may include the time aligned data signal.

When the sensor nodes 104a-104n and the reference node 106 (FIG. 3A) receive a data signal (e.g., a response to a probe signal transmitted by the sensor nodes that is reflected off an object such as a target resource deposit), the sensor nodes 104a-104n and the reference node 106 transmit the received data signal to the central processing node 108. For example, the first sensor node 104a and the reference node 106 transmit the received first data signal and a reference data signal, respectively, to the central processing node 108. The central processing node 108 may then retrieve the first time offset from a storage device (not shown) and apply it to the first data signal to generate a first time aligned data signal of the first sensor node 104a. Similarly, the central processing node 108 may apply the second time offset to the second data signal of the second sensor node 104b to generate a second time aligned data signal of the second sensor node 104b.

In some embodiments, a plurality of transceiver nodes (e.g., sensor nodes 104a-104n) each outputs a corresponding primary beam 112 (FIG. 5A and 5B) composed of the output from the plurality of antenna elements 306, wherein each of the plurality of transceiver nodes 104a-104n is disposed to surveil at least a portion of a range and/or angle extent of the at least field of regard 503 (FIG. 5A or 5B). In supplemental embodiments, the adaptive beam pattern 114 includes an isotropic configuration used to surveil an omnidirectional area of interest 502 (FIG. 5A) or field of regard 503 (FIG. 5B).

In some embodiments, the distributed system 100 (FIG. 1) takes a snapshot of each of the sensor nodes 104a-104n at the synchronized timestamp. The snapshot may include a matrix X comprising a corresponding time aligned data signal (x1-xn) for each of the plurality of antenna elements 306. In some embodiments, the central processing node 108 directs the plurality of transceiver nodes 104a-104n to capture a plurality of snapshots of the at least one target 102 (FIG. 5A or 5B), where each of the plurality of snapshots is captured when a corresponding read beam coincides with the at least one target 102. Accordingly, the central processing node 108 captures snapshots that may characterize the distributed system's 100 response to target acquisition. Because sensor nodes 104a-104b may be software-defined radios (SDR), any appropriate time aligned snapshot data may be reproduced without distortion for each of the nodes 104a-104n and their corresponding plurality of antenna elements 306. In some embodiments, the snapshot data may be included in the status information generated by the sensor nodes 104a-104b. Multiple snapshots (x1-xn) of the sensor nodes 104a-104b may facilitate the production of multiple simultaneous read beams within a field of regard 503 (FIG. 5B). In some embodiments, the process of cohering the weight vector W to the time aligned snapshot data X results in the generation of the adaptive beam pattern 114 (FIG. 5A or 5B) that adapts in relation to the time aligned snapshot data X. Accordingly the coherence operations executed by the central processing node 108 uses the corresponding weight vector for each of the plurality of snapshots to form a high-gain received signal (e.g., 114 shown in FIG. 5A and 5B, 810 shown in FIG. 8, etc.).

### Example Flowchart(s)

The example flowchart(s) described herein convey example processing operations of methods that enable the various features and functionality of the system as described in detail above. The processing operations of each method presented below are intended to be illustrative and non-limiting. In some embodiments, for example, the methods may be accomplished with one or more additional operations not described, and/or without one or more of the operations discussed. Additionally, the order in which the processing operations of the methods are illustrated (and described below) is not intended to be limiting.

In some embodiments, the methods may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on an electronic storage medium. The processing devices may include one or more devices configured through hardware, firmware, and/or software to be specifically designed for execution of one or more of the operations of the methods.

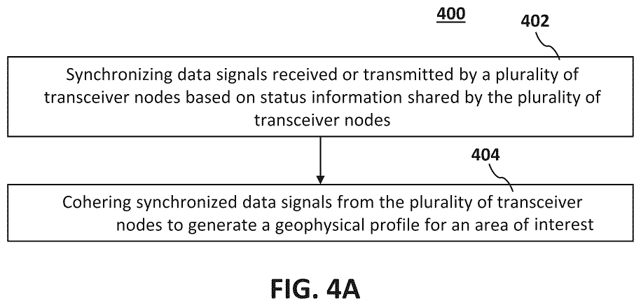

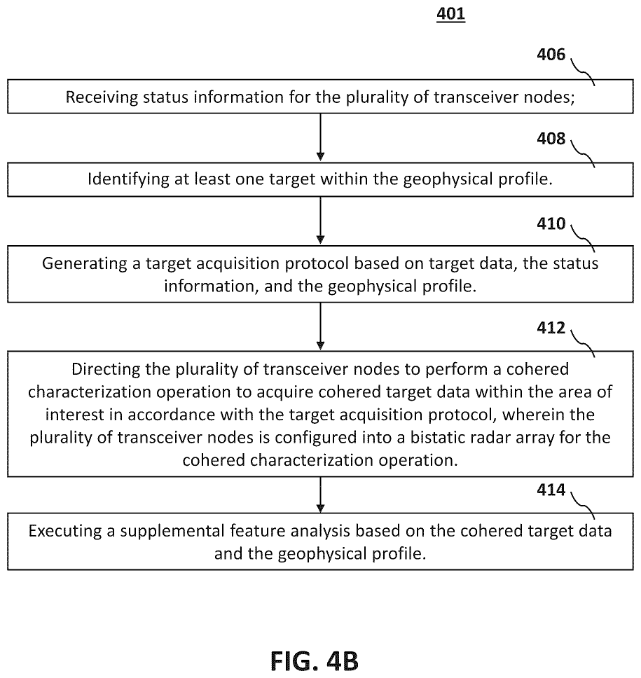

FIG. 4A shows a flowchart of a method 400 for employing the sensor nodes 104a-104n of the distributed system 100 (FIG. 1) to perform GPR surveying using adaptive beamforming. In some embodiments, the sensor nodes 104a-104n are a plurality of transceiver nodes 104a-104n (e.g., a plurality of isotropic antenna arrays). The method 400 may begin by synchronizing, via a processor (e.g., central processing node 108 shown in FIG. 1, DSP 206 shown in FIG. 2), data signals received or transmitted by the plurality of transceiver nodes 104a-104n based on status information shared by the plurality of transceiver nodes 104a-104n (operation 402 shown in FIG. 4A). For example, the processor 108 may time-synchronize the output of the plurality of transceiver nodes 104a-104n via the calibration signal 304 and reference node 106 (FIG. 3A). The method 400 may continue by cohering, via the processor 108, synchronized data signals from the plurality of transceiver nodes to generate a geophysical profile 501 for an area of interest 502 (operation 404 shown in FIG. 4A). The process of cohering the data signals from the plurality of transceiver nodes 104a-104n to generate the geophysical profile 501 rnables the system to determine all geophysical features that exist beneath the area of interest. The profile can be further refined by performing subsequent sounding operations.

In some embodiments, the method 400 may continue by identifying, via the processor 108 (FIG. 1), an interference profile for the area of interest 502, wherein the interference profile 501 includes at least one interference source (e.g., background noise, electromagnetic interference, etc.). The geophysical profile 501 may include all relevant characteristics (e.g., depth, optimal number of sensor nodes, optimal sensor node placement, angle or direction of approach, location, frequency, directionality, signal strength) for the at least one target resource and/or geological feature positioned within the area of interest 502. Further, the geophysical profile 501 may contain information gathered from external sources and may be updated based on user preference. For example, the geophysical profile 501 may make it clear that the adaptive beam pattern 114 (FIG. 5A or 5B) needs to be tuned to accommodate for significant seismic activity that has occurred since the last sounding.

FIG. 4B shows a subprocess 401 for acquiring cohered target data in preparation for supplemental feature analysis according an embodiment of the system 100 and may include receiving, via a processor (e.g., central processing node 108 shown in FIG. 1, DSP 206 shown in FIG. 2) status information for the plurality of transceiver nodes 104a-104b (operation 406 shown in FIG. 4B). The transceiver nodes 104a-104n may be used to gather status information about the area of interest 502 (FIG. 5A) and thereby facilitate the creation of the geophysical profile 501 that is a virtualized model of the plurality of substrata layers 505 beneath the area of interest. The subprocess 401 may include identifying, via the processor 108, at least one target 102 (e.g., target resources, geologic features, drill bits, etc.) within the geophysical profile 501 (FIG. 5B) characterized by the distributed system 100 (operation 408 shown in FIG. 4B). For example, the user may specify the target resource is petroleum, and the subprocess 401 may perform a general survey of the geophysical profile 501 to determine if petroleum exists in any of the plurality of substrata layers 505. This general survey may be low resolution to reduce the processing overhead required to perform the overall operation. The subprocess 401 may include generating, via the processor, a target acquisition protocol based on target data, the status information, and the geophysical profile 501 (operation 410 shown in FIG. 4B). In some embodiments, the target acquisition protocol may include the routines and subprocesses required to identify optimal sounding nodes within the plurality of sensor nodes 104a-104n for penetrating to a desired depth (e.g., substrata layer 505 (FIG. 5A)) while maintaining a desired target 102 resolution length. The target acquisition protocol may include frequency data for the plurality of transceiver nodes 104a-104n and the adaptive interrogation signal 114, information about a desired number and position of transceiver nodes 104a-104n, depth data, geological feature data, dielectric property data, waveform data, and cumulative output gain data.

In some embodiments, operation 410 may include plotting, via the processor 108, a location of at least one geological feature within the area of interest 502. For example, the system may determine that rare earth minerals are distributed through a plurality of substrata layers 505 (FIG. 5A). Operation 410 may further include analyzing, via the processor 108, the status information, target data, and the geophysical profile to identify at least one transmitter node 104a and at least one receiver node 104b from the plurality of transceiver nodes 104a-104n. The transmitter node 104a may generate an interrogation signal (e.g., adaptive beam pattern 114 (see FIG. 5A described below), probe signal 808 (see FIG. 8 described below), and/or data signal 810 (see FIG. 8 described below)) that is reflected off geological features within the geophysical profile 501 and received by the receiver node 104b alone, the transmitter node alone 104a, or a combination thereof. In some embodiments a plurality of transmitter nodes 104a and a plurality of receiver nodes 104b are employed such that transmitter nodes 104a are also receiver nodes 104b and receiver nodes 104b are also transmitter nodes 104a.

In some embodiments, the system 100 may use a machine learning model to enable the plurality of transceiver nodes 104a-104n to be algorithmically coupled into a dynamically reconfigured GPR subarray. For example, the central processing node 108 may dynamically determine if at least one arbitrary transceiver node 104a-104n should be assigned to participate in subsurface target characterization and/or supplemental feature analysis. This dynamic determination may be based on at least one of a signal's angle of arrival (AOA) relative to subsurface features, the characteristics of at least one substrata layer 505 (FIG. 5A), a desired adaptive beam pattern 114, a current position and/or path of travel of a target drill bit 102 (FIG. 5B), operational capacity (e.g. functioning properly or malfunctioning). Thus, the system 100 is able to employ varying configurations of transceiver nodes 104a-104n that enable the processor 108 to determine the appropriate transceiver nodes based on at least one node selection criteria (e.g., processor node availability, physical location in relation to the at least one other node 104a-104n, type of processing task, user preference). Once the appropriate configuration of transceiver nodes 104a-104n is selected, operation 410 may further include generating, via the processor 108, an instruction set for characterizing the at least one target 102 resource parameter through analysis of geophysical, geological, and/or structural data with the least one transmitter node 104a and the at least one receiver node 104b. The instruction set may include steering vectors, adaptive beam weights, and target resource parameters that dictate how each of the plurality of transceiver nodes 104a-104n should operate in concert to identify the desired data within the area of interest 502. In some embodiments the at least one receiver node is selected based on an output gain of the at least one transmitter node. Alternatively, the at least one receiver node may be selected based on a desired input gain at the at least one receiver node. In some embodiments, system 100 operates as a radar system whenever an electromagnetic echo return is received from the at least one target 102. The at least one target may be within a Fresnel zone of at least one arbitrary transceiver node from the plurality of transceiver nodes. Further, the processor may apply non-linear predistortion methods that use a known electrical permittivity of the earth and a known reference source to account for non-linearities in the deep earth.

The subprocess 401 may include directing, via the processor 108, the plurality of transceiver nodes 104a-104n to perform a cohered characterization operation to acquire cohered target data within the area of interest 502 in accordance with the target acquisition protocol (operation 412 shown in FIG. 4B). The subprocess 401 may further include executing, via the processor 108, supplemental feature analysis based on the cohered target data and the geophysical profile (operation 414 shown in FIG. 4B). For example, the cohered characterization operation may highlight the presence of rare earth minerals within the plurality of substrata layers 505, and the supplemental feature analysis may be used to identify only those deposits with a return on investment that would exceed the cost of extraction.

FIG. 5A shows an embodiment where the plurality of sensor nodes 104a-104n is configured into a multistatic array capable of surveying and cohering the plurality of substrata layers 505 to form the 3D geophysical profile 501 used to characterize the area of interest. The cohered characterization operation may include outputting, via the at least one transmitter node, the at least one adaptive interrogation signal directed 114 toward the area of interest in accordance with the target acquisition protocol. For example, the adaptive interrogation signal 114 may be dynamically steered along a path of travel 504 to survey the 3D volume of earth beneath the area of interest 502. The path of travel may be adaptively generated to perform sounding operations and supplemental feature analysis most efficiently. The adaptive interrogation signal 114 may be produced as a function of the plurality of cohered primary beams 112 generated by the plurality of transceiver nodes 104a-104n. For example, the processor 108 may be constantly adding or subtracting active sensor nodes 104a-104n as stipulated by the target acquisition protocols. The target acquisition protocol may further include adjusting the beam weights for the corresponding primary beams 112 output by each active sensor node 104a-104 such that the adaptive interrogation signal 114 is able to generate high resolution geophysical profiles within regions containing complex geological structures by adapting for region specific features that may arise with layer by layer granularity. In some embodiments, the plurality of transceiver nodes 104a-104n employs near-field electromagnetic induction during the cohered characterization operation. In some embodiments, the processor 108 directs the plurality of transceiver nodes 104a-104n to operate as an adjustable pulse radar array, and wherein the processor 108 employs intrapulse modulation and pulse compression to improve range resolution.

The cohered characterization operation may further include receiving, via the at least one receiver node 104b, at least one reflected signal from within the 3D volume beneath the area of interest 502, wherein the at least one receiver node 104a-104n is selected based on a position of the at least one receiver node 104b relative to the at least one transmitter node 104a and the area of interest 502 in accordance with the target acquisition protocol. Likewise, the number of active transceiver nodes 104a-104n and/or their configuration may change during the cohered characterization operation so that the adaptive interrogation signal 114 may be tuned to account for the relevant geophysical features for characterizing the target feature parameters and/or desired substrata layers 505. For example, if the reflected signal were to indicate the presence of a significant petroleum deposit in a lowest substrata layer beneath a northwestern portion of the area of interest, the cohered characterization operation may recruit a large number of northwesterly disposed sensor nodes 104a-104n and thereby ensure the necessary signal penetration and resolution. The cohered characterization operation may include generating, via the processor, an equalized signal from the at least one reflected signal 114, wherein the equalization removes noise from the geophysical profile 501 in accordance with the target acquisition protocol. For example, the noise may be background noise caused by dispersion and/or attenuation of the signal moving through different substances and substrata layers 505. In some embodiments a range, scope, and/or extend of the field of regard 503 may change based on the configuration of the sensor nodes 104a-104n used to produce the adaptive interrogation signal 114.

FIG. 5B shows an embodiment where supplemental feature analysis is used to track and/or guide at least one target drill bit 102 for a geosteering operation. In some embodiments, the geosteering operation facilitates optimal placement of a wellbore relative to 3D coordinates in space as derived from the results of the cohered characterization operation. Such derivation may augment real-time downhole geological and geophysical logging measurements. Accordingly, the geosteering operation may include outputting, via the at least one transmitter node 104a, the at least one adaptive interrogation signal 114 directed toward the target drill bit 102 within the area of interest 502, and receiving, via the at least one receiver node 104b, at least one reflected signal 114 from the target drill bit 102. In some embodiments, the at least one receiver node 104b is selected relative to a position of the at least one transmitter node 104a and/or the target drill bit. 102. The geosteering operation may further include tuning, via the processor 108, a frequency of the at least one adaptive interrogation signal 114 to scan an area surrounding the target drill bit 102 as the target drill bit 102 moves through the area of interest 502 along the path of travel 504. In some embodiments, the geosteering operation includes determining at least one of the target drill bit's pitch, orientation, azimuth, and velocity.

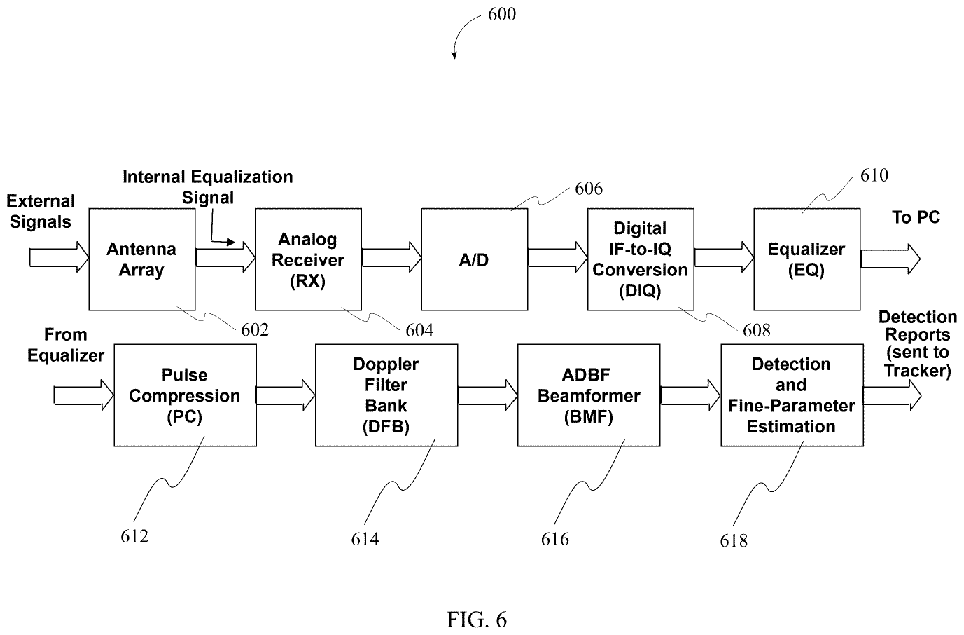

In some embodiments, the supplemental feature analysis is a monitoring operation that takes longitudinal measurements of the area of interest and may include periodically outputting, via the at least one transmitter node 104a (FIG. 5A), the at least one adaptive interrogation signal 114 directed toward the area of interest 502. The monitoring operation may further include receiving, via the at least one receiver node 104b, at least one periodically reflected signal from the area of interest 502, wherein the at least one receiver node 104b is selected based on a position of the at least one receiver node 104b relative to the at least one transmitter node 104a and a time varying relationship to a previous state of the area of interest 502. For example, if the system is used to monitor the water level in an aquifer the transmitter nodes 104a and the receiver nodes 104b may be advantageously positioned to determine if the water level has fallen below a desired threshold. In some embodiments, the monitoring operation may include appending, via the processor, current cohered target data to a geological data log and generating a time-varying representation of the geological data log via the processor. Thus, facilitating data visualization and processing. For example, the distributed system may scan the field of regard 503 (FIG. 5B) to determine the presence of the target 102 (FIG. 5A or 5B and also see FIG. 6). Additionally, the distributed system may be directed to acquire a target at a known position. The method 400 may continue by generating, via the processor 108, an interference mitigation protocol based on target data, the status information, and the interference profile (operation 408). The interference mitigation protocol may contain the tuning values for W that enable the plurality of transceiver nodes 104a-104n and the plurality of antenna elements 306 (FIG. 3B) to output the desired adaptive beam pattern 114.

FIG. 6 shows a block diagram illustrating signal processing operations 600 for some embodiments of the distributed system 100 (FIG. 1). An external signal (e.g., high-directionality beam 114 (FIG. 5A), data signal 810 (FIG. 8)) received by the antenna array 602 (e.g., antenna elements 306 (FIG. 3B)) is transferred to an analog receiver 604 to be adjusted to account for an internal equalization signal (e.g., calibration signal 304 (FIG. 3A)). The adjusted signal may then be transferred to an analog-to-digital converter 606 before being transferred to a complex value converter 608 where the received signal is then downconverted to baseband such that the subsequent processing can be done in a complex-valued baseband domain. The signal is then sent to an equalizer 610 where the excitation data (e.g., wa-wn (FIG. 3B)) from the plurality of antenna elements 306 in each transducer node 104a-104b is cohered to form a time aligned signal. Operations 602-610 can be seen as cohering and equalization, operations 612 and 614 facilitate the generation of a geophysical profile 501, and operations 616 and 618 are directed toward generating the adaptive beam pattern 114 (FIG. 5A or 5B), performing supplemental feature analysis, and increasing signal quality. Turning to operations 612 and 614, the target acquisition protocol can be broadly seen as a protocol for increasing the SNR of the distributed system 100. Operation 612 may employ pulse compression techniques to provide SNR gain, isolation of the target 102 data signal in range and strong close-range clutter reduction. Similarly, operation 614 may further isolate the signal by employing doppler filtering techniques to provide SNR gain, isolation of the target 102 in doppler (which corresponds to range-rate), clutter nulling, and low doppler sidelobes to suppress interference sources at other range-rates.

In some embodiments, each of the plurality of transceiver nodes 104a-104n includes at least one low frequency solid-state power amplifier that operates within a range of 0.1 Hz to 1 MHz and transmits a wideband Compressed, High-Resolution Pulse, (CHIRP) waveform to produce high-resolution profiles of subsurface features. In further embodiments, each of the plurality of sensor nodes 104a-104n (FIG. 3B) produces a non-continuous chirp waveform across several frequency bands. For example, the system 100 may employ linear, non-linear, phase, and/or frequency pulse modulation to improve the range resolution for a relatively long transmission pulse duration by modulating the transmission pulse. Thus modulated, a frequency comparison can be made in the received echo, for example, which makes it possible to localize the reflecting object within the pulse. In some embodiments, system 100 uses phase-encoded pulse compression and/or modulation to divide long pulses into smaller sub-pulses of equal length whose carrier frequency does not change. Within this pulse duration of the sub-pulses, the phase is constant. These sub-pulses represent a range-cell, i.e. the smallest resolvable distance. Embodiments may use a phase jump linked to a barker code. Further, because only 13 Barker codes have a maximum signal-to-sidelobes ratio, the selection of a suitable Barker code greatly simplifies the identification of an optimum pulse pattern. For example, this optimum may be measured at the level of the expected sidelobes and it can, thus be concluded that no greater number of pulses than this 13 is possible for Barker codes and that the number of 13 subpulses therefore also represents a maximum achievable pulse compression ratio of 13:1. System may further combine Barker codes to form nested Barker codes. For example, an 11-digit Barker code can be used, and within each of these 11 partial pulses, a further 11-digit Barker code is used. This results in a division into a total of 121 sub-pulses. In some embodiments, the central processing node 108 (FIG. 1, FIG. 3B) may employ a machine learning algorithm to implement operations 612 and 614 (FIG. 6) via a software-defined adaptive filter for separating a signal of interest from background noise. Further, the software-defined adaptive filter enables the distributed system 100 to account for the high variability between substrata layer composition (e.g., estimating net pay thickness, porosity, and fluid type during prospecting) (FIG. 5A or 5B) when generating the adaptive beam pattern 114 (FIG. 5A or 5B). A subprocess for implementing the software-defined adaptive filter may begin by identifying a domain for interference removal prior to separating the signal of interest, wherein the domain is at least one of temporal (fast time, slow time), spatial, polarization, or combinations thereof. Accordingly, the software-defined adaptive filter may determine the optimal combination of primary beams 112 (FIG. 5A or 5B) required to maximize directionality, gain, and SNR of the adaptive beam pattern 114. In some embodiments, the software-defined adaptive filter is trained using the current geophysical profile 501 as well as previously calculated geophysical profiles and adaptive beam patterns 114. Accordingly, the distributed system 100 improves the SNR without the need for user-guided tuning. Further, the software-defined adaptive filter may identify hidden or foreign artifacts in the read beams or data signals exciting the transducer nodes 104a-104b. Thus, the software-defined adaptive filter may help to identify unforeseen data that may facilitate the generation of high-fidelity geophysical profiles 501.

In some embodiments, the adaptive filter (e.g., operation 612 and 614 (FIG. 6)) works in concert with the transducer nodes 104a-104b to enable adaptive digital beamforming operations 616. Adaptive beamforming may describe the process of generating high gain and/or high-directionality beams 114 to conduct geophysical surveys capable of identifying and classifying geological features within the area of interest 502. To facilitate this functionality, the adaptive filter may form a feedback loop with the transducer nodes 104a-104b such that the efficacy of the adaptive beam pattern 114 in identifying target resource parameters, mitigating interference, and generating beams is continuously monitored and the output for each transducer node 104a-104n can be individually tuned to accommodate for changes in local geological properties (e.g., flooding, tectonic activity, permafrost melting). In some embodiments, operation 616 may execute the following processes for obtaining SNR gain on targets resource parameters: isolation of the target resource parameters for a given AOA, (i.e., azimuth and elevation), and adaptive beamforming to accommodate for varying geological properties between the plurality of substrata layers 505.

In some embodiments, the feedback loop of operation 616 (FIG. 6) is further refined in operation 618 where the central processing node may modify the adaptive beam pattern to focus the adaptive beam pattern 114 (FIG. 5A and 5B) on an arbitrary layer within the plurality of substrata layers 505 that contains the desired target resource parameters.

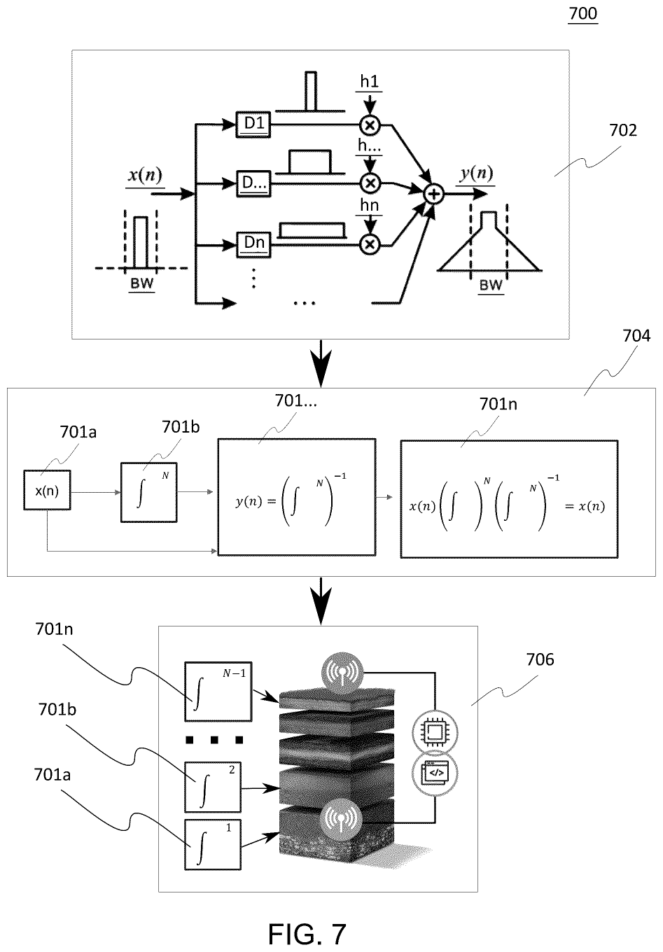

As shown in FIG. 7, operation 412 may direct the system 100 to incorporate the data gathered from a previously generated geophysical profile 501 into the status information for a supplemental feature analysis operation. This additional supplemental feature analysis focuses on the arbitrary layer 505 and performs adaptive beamforming operations to generate a higher resolution geophysical profile 501 that highlights the desired target resource parameters within the arbitrary layer 505. In some embodiments, the central processing node 108 may employ the plurality of transducer nodes 104a-104b for interferometry operations to estimate a signal's AOA. The interferometry may include pairwise phase comparison to estimate both AOA and a spacing between array elements that is greater than lambda/2. The cohering may occur prior to, or simultaneously with, a subprocess 700 for the creation of a transfer-function based representation y(n) of the geophysical profile 501, as characterized by the adaptive beam pattern 114. This subprocess 700 may include employing non-linear transfer function techniques (e.g., ensemble empirical mode decomposition (EEMD), Hilbert-Huang transform (HHT), logarithmic transform, etc.) to decompose the raw status information x(n) (e.g., w1a-wNa, w1b-wNb, w1n-wNn) for the plurality of transceiver nodes 104a-104n into a plurality of representative substrata functions (Block 702); each of which is representative of a corresponding substrata layer 505 (Block 704). Further, each of the plurality of representative substrata functions 701a-701n may be characterized by a substrata dielectric weight vector D1-Dn and a substrata beam weight h1-hn vector. The subroutine may include generating a visual rendering of the transfer-function based representation y(n) as depicted in Block 706.

The distributed GPR system 100 may focus on and/or filter out any of the plurality of substrata layers 505 by resolving a corresponding substrata weight from the plurality of substrata weights D1-Dn such that the adaptive beam pattern 114 is tuned as desired. In some embodiments, the non-linear decomposition techniques enable the distributed GPR system 100 to decompose node excitation data wa-wn into frequency components and noise components and then filter the unwanted noise components of the signal. This decomposition and subsequent resolving of only the relevant signal information reduces the processing overhead required to analyze and/or interact with the data signal during supplemental feature analysis of target data and the geophysical profile (e.g. removing signal data for all layers but the corresponding substrata layer 505, removing unwanted target resources from block 706 representations of the geophysical profile 501, performing additional soundings of the corresponding substrata layer 505 to improve resolution of the target resources, focusing on a specific subsection of the corresponding substrata layer 505. Further, in some embodiments, the instruction set for characterizing the at least one target within the corresponding substrata layer 505 includes output characteristics for at least one adaptive interrogation signal 114 (FIG. 5A) that may vary as the area of interest 502 is scanned during the cohered characterization operation. Accordingly, the adaptive beam pattern 114 may be tuned to focus on, or accommodate for, each of the plurality of substrata layers during sounding and/or geosteering operations.

FIG. 8 is a block diagram of a GPR system 800 implemented using the distributed system 100 of FIG. 1, consistent with various embodiments. The radar system 800 includes a number of sensor nodes (e.g., sensor nodes 804a, 804b, 804c, 804d, and 804e) that are configured to facilitate surveillance of a moving object (e.g., detection of a drill bit 802). In some embodiments, the sensor nodes 804a-804e are similar to the sensor nodes 104a-104n of the distributed system 100. In some embodiments, one of the sensor nodes 804a-804e may be designated as a reference node and a central processing node. In some embodiments, all the sensor nodes 804a-804e are configured as transmit and receive sensor nodes. The sensor nodes 804a-804e may be time synchronized as described at least with reference to FIGS. 4A, 4B, 5A, and 5B above. Further, the time aligned signals may be cohered as described at least with reference to FIG. 6 above.

The sensor nodes 804a-804e are configured to transmit a probe signal 808 in a beamforming pattern. The signals reflected from target 802 (e.g., drill bit, bottom hole assembly, target mineral, etc.) may be received by the sensor nodes as data signals 810. The data signals 810 are time aligned, cohered, and processed to determine one or more parameters of the drill bit 802 (e.g., distance or speed of the drill bit).

While FIG. 8 shows a single cluster of sensor nodes 804a-804e, the radar system 800 may have several clusters. In some embodiments, each black dot in FIG. 8 may be a cluster of sensor nodes. For example, the black dot 804a can be a first cluster, the black dot 804b can be a second cluster and so on, each of which includes several sensor nodes. In some embodiments, such a configuration enables high-resolution analysis of geological and geophysical features. In some embodiments, the sensor nodes or clusters may be spread over a few hundred meters or distributed across a large geographic region.

The distributed system 100 may also be implemented as a mobile sensor array system. For example, the sensor nodes 104a-104n may be designed as mobile sensor nodes that are battery powered, solar powered, etc. and may be installed in an automobile, an unmanned aerial vehicle (UAV), or other mobile devices.

While FIG. 8 describes implementation of the distributed system 100 as a GPR system, the distributed system 100 may also be implemented as a sonar system to facilitate surveillance of objects moving underwater (e.g., a submarine). For example, the sensor nodes 104a-104n may be configured as hydrophone sensor nodes, which can be installed as buoys or as mobile hydrophones (e.g., in submarines). The hydrophone sensor nodes 104a-104n may be associated with above water components that communicate with satellites and have GPS capability.

In some embodiments, the various components or modules illustrated in the Figures or described in the foregoing paragraphs may include one or more computing devices that are programmed to perform the functions described herein. The computing devices may include one or more electronic storages, one or more physical processors programmed with one or more computer program instructions, and/or other components. The computing devices may include communication lines or ports to enable the exchange of information within a network or other computing platforms via wired or wireless techniques (e.g., Ethernet, fiber optics, coaxial cable, Wi-Fi, Bluetooth, near field communication, or other technologies). The computing devices may include a plurality of hardware, software, and/or firmware components operating together. For example, the computing devices may be implemented by a cloud of computing platforms operating together as the computing devices. Cloud components may include control circuitry configured to perform the various operations needed to implement the disclosed embodiments. Cloud components may include cloud-based storage circuitry configured to electronically store information. Cloud components may also include cloud-based input/output circuitry configured to display information.

The electronic storages may include non-transitory storage media that electronically stores information. The storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information obtained from servers, information obtained from client devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent processing functionality of a plurality of devices operating in coordination. The processors may be programmed to execute computer program instructions to perform functions described herein. The processors may be programmed to execute computer program instructions by software; hardware; firmware; some combination of software, hardware, or firmware; and/or other mechanisms for configuring processing capabilities on the processors.

It should be appreciated that the description of the functionality provided by the components or modules described herein is for illustrative purposes, and is not intended to be limiting, as any of the components or modules may provide more or less functionality than is described. For example, one or more of the components or modules may be eliminated, and some or all of its functionality may be provided by other ones of the components or modules. As another example, additional components or modules may be programmed to perform some or all of the functionality attributed herein to one of the components or modules.

The following list of clauses describes various aspects of the systems and methods described herein, which may be combined in any combination.

1: A method for deep earth penetrating multi-static ground mapping radar, may include: synchronizing, via a processor, data signals received or transmitted by a plurality of transceiver nodes based on status information shared by the plurality of transceiver nodes; and cohering, via the processor, synchronized data signals from the plurality of transceiver nodes to generate a geophysical profile for an area of interest.

2: The method as clause 1 describes, further may include: receiving, via the processor, status information for the plurality of transceiver nodes; identifying, via the processor, at least one target within the geophysical profile; generating, via the processor, a target acquisition protocol based on target data, the status information, and the geophysical profile; directing, via the processor, the plurality of transceiver nodes to perform a cohered characterization operation to acquire cohered target data within the area of interest in accordance with the target acquisition protocol, where the plurality of transceiver nodes is configured into a bistatic radar array for the cohered characterization operation; and executing, via the processor, supplemental feature analysis based on the cohered target data and the geophysical profile.

3: The method as either of clauses 1 or 2 describe, where generating the target acquisition protocol includes: plotting, via the processor, a location of at least one geological feature within the area of interest; analyzing, via the processor, the status information, target data, and the geophysical profile to identify at least one transmitter node and at least one receiver node from the plurality of transceiver nodes; and generating, via the processor, an instruction set for characterizing the at least one target through analysis of geophysical, geological, and structural data with the least one transmitter node and the at least one receiver node.

4: The method as any of clauses 1-3 describe, where the at least one receiver node is selected based on an output gain of the at least one transmitter node.

5: The method as any of clauses 1-4 describe, where the at least one receiver node is selected based on a desired input gain at the at least one receiver node.

6: The method as any of clauses 1-5 describe, where the at least one geological feature includes at least one of hydrocarbon deposits, metal/mineral deposits, ground water reservoirs, geothermal regions, oil and gas traps, stratigraphic unconformity, faults, pinch-outs, facies change, dielectric coefficients, rock structure, and stratigraphy data.

7: The method as any of clauses 1-6 describe, where the instruction set for characterizing the at least one target includes output characteristics for at least one adaptive interrogation signal that may vary as the area of interest is scanned during the cohered characterization operation.

8: The method as any of clauses 1-7 describe, where the cohered characterization operation includes: outputting, via the at least one transmitter node, the at least one adaptive interrogation signal directed toward the area of interest in accordance with the target acquisition protocol; receiving, via the at least one receiver node, at least one reflected signal from the area of interest, where the at least one receiver node is selected based on a position of the at least one receiver node relative to the at least one transmitter node and the area of interest in accordance with the target acquisition protocol; and generating, via the processor, an equalized signal from the at least one reflected signal, where the equalization removes noise from the geophysical profile in accordance with the target acquisition protocol.

9: The method as any of clauses 1-8 describe, where the supplemental feature analysis is a geosteering operation that includes: outputting, via the at least one transmitter node, the at least one adaptive interrogation signal directed toward a drill bit within the area of interest; receiving, via the at least one receiver node, at least one reflected signal from the drill bit, where the at least one receiver node is selected based on a position of the at least one receiver node relative to the at least one transmitter node and the drill bit; and tuning, via the processor, a frequency of the at least one adaptive interrogation signal to scan an area surrounding the drill bit as the drill bit moves through the area of interest.

10: The method as any of clauses 1-9 describe, where the supplemental feature analysis is a geosteering operation that includes determining at least one of the drill bit's pitch, orientation, azimuth, and velocity.

11: The method as any of clauses 1-10 describe, where the supplemental feature analysis is a monitoring operation that includes: periodically outputting, via the at least one transmitter node, the at least one adaptive interrogation signal directed toward the area of interest; receiving, via the at least one receiver node, at least one periodically reflected signal from the area of interest, where the at least one receiver node is selected based on a position of the at least one receiver node relative to the at least one transmitter node and a time varying relationship to a previous state of the area of interest; and appending, via the processor, current cohered target data to a geological data log.

12: The method as any of clauses 1-11 describe, where the monitoring operation includes generating a time-varying representation of the geological data log via the processor.

13: The method as any of clauses 1-12 describe, where the plurality of transceiver nodes operates in a range of 1 hrz-200 khz.

14: The method as any of clauses 1-13 describe, where the plurality of transceiver nodes is configured into a multi-static radar array.

15: The method as any of clauses 1-14 describe, where the processor directs the plurality of transceiver nodes to operate as an adjustable pulse radar array, and where the processor employs intrapulse modulation and pulse compression to improve range resolution.

16: The method as any of clauses 1-15 describe, where the target acquisition protocol includes frequency data, information about a desired number and position of transceiver nodes, depth data, geological feature data, dielectric property data, waveform data, and cumulative output gain data.

17: The method as any of clauses 1-16 describe, where each of the plurality of transceiver nodes are wirelessly coherent and wirelessly coupled to form a multi-static phased array.

18: The method as any of clauses 1-17 describe, where the plurality of transceiver nodes employs near-field electromagnetic induction during the cohered characterization operation.

19: The method as any of clauses 1-18 describe, where the plurality of transceiver nodes operates as a radar system whenever an electromagnetic echo return is received from the at least one target.

20: The method as any of clauses 1-19 describe, where the at least one target is within a Fresnel zone of at least one arbitrary transceiver node from the plurality of transceiver nodes.

21: The method as any of clauses 1-20 describe, where the processor applies non-linear predistortion methods that use a known electrical permittivity of the earth and a known reference source to account for non-linearities in the deep earth.

22: The method as any of clauses 1-21 describe, where each of the plurality of transceiver nodes includes at least one low frequency solid-state power amplifier that operates within a range of 1 Hz to 1 MHz.

23: The method as any of clauses 1-22 describe, where the at least one solid-state power amplifier transmits a wideband chirp waveform to produce high-resolution profiles of subsurface features.

24: The method as any of clauses 1-23 describe, where the at least one solid-state power amplifier produces a non-continuous chirp waveform across several frequency bands.

25: A system for deep earth penetrating multi-static ground mapping radar may include: one or more processors configured to: synchronize data signals received or transmitted by a plurality of transceiver nodes based on status information shared by the plurality of transceiver nodes; and cohere synchronized data signals from the plurality of transceiver nodes to generate a geophysical profile for an area of interest.

26: The system as clause 25 describes, further may include: the one or more processors further configured to: receive status information for the plurality of transceiver nodes identify at least one target within the geophysical profile generate a target acquisition protocol based on target data, the status information, and the geophysical profile direct the plurality of transceiver nodes to perform a cohered characterization operation to acquire cohered target data within the area of interest in accordance with the target acquisition protocol, where the plurality of transceiver nodes is configured into a bistatic radar array for the cohered characterization operation; and execute supplemental feature analysis based on the cohered target data and the geophysical profile.

27: The system as either of clauses 25 or 26 describe, where generating the target acquisition protocol includes: the one or more processors further configured to: plot a location of at least one geological feature within the area of interest analyze the status information, target data, and the geophysical profile to identify at least one transmitter node and at least one receiver node from the plurality of transceiver nodes; and generate an instruction set for characterizing the at least one target through analysis of geophysical, geological, and structural data with the least one transmitter node and the at least one receiver node.

28: The system as any of clauses 25-27 describe, where the at least one receiver node is selected based on an output gain of the at least one transmitter node.

29: The system as any of clauses 25-28 describe, where the at least one receiver node is selected based on a desired input gain at the at least one receiver node.

30: The system as any of clauses 25-29 describe, where the at least one geological feature includes at least one of hydrocarbon deposits, metal/mineral deposits, ground water reservoirs, geothermal regions, oil and gas traps, stratigraphic unconformity, faults, pinch-outs, facies change, dielectric coefficients, rock structure, and stratigraphy data.

31: The system as any of clauses 25-30 describe, where the instruction set for characterizing the at least one target includes output characteristics for at least one adaptive interrogation signal that may vary as the area of interest is scanned during the cohered characterization operation.

32: The system as any of clauses 25-31 describe, where the cohered characterization operation includes: outputting, via the at least one transmitter node, the at least one adaptive interrogation signal directed toward the area of interest in accordance with the target acquisition protocol receiving, via the at least one receiver node, at least one reflected signal from the area of interest, where the at least one receiver node is selected based on a position of the at least one receiver node relative to the at least one transmitter node and the area of interest in accordance with the target acquisition protocol; and generating an equalized signal from the at least one reflected signal, where the equalization removes noise from the geophysical profile in accordance with the target acquisition protocol.

33: The system as any of clauses 25-32 describe, where the supplemental feature analysis is a geosteering operation that includes: outputting, via the at least one transmitter node, the at least one adaptive interrogation signal directed toward a drill bit within the area of interest receiving, via the at least one receiver node, at least one reflected signal from the drill bit, where the at least one receiver node is selected based on a position of the at least one receiver node relative to the at least one transmitter node and the drill bit; and tuning a frequency of the at least one adaptive interrogation signal to scan an area surrounding the drill bit as the drill bit moves through the area of interest.

34: The system as any of clauses 25-33 describe, where the supplemental feature analysis is a geosteering operation that includes determining at least one of the drill bit's pitch, orientation, azimuth, and velocity.

35: The system as any of clauses 25-34 describe, where the supplemental feature analysis is a monitoring operation that includes: periodically outputting, via the at least one transmitter node, the at least one adaptive interrogation signal directed toward the area of interest receiving, via the at least one receiver node, at least one periodically reflected signal from the area of interest, where the at least one receiver node is selected based on a position of the at least one receiver node relative to the at least one transmitter node and a time varying relationship to a previous state of the area of interest; and appending current cohered target data to a geological data log.

36: The system as any of clauses 25-35 describe, where the monitoring operation includes generating a time-varying representation of the geological data log via the processor.

37: The system as any of clauses 25-36 describe, where the plurality of transceiver nodes operates in a range of 1 hrz-200 khz.

38: The system as any of clauses 25-37 describe, where the plurality of transceiver nodes is configured into a multi-static radar array.

39: The system as any of clauses 25-38 describe, where the processor directs the plurality of transceiver nodes to operate as an adjustable pulse radar array, and where the processor employs intrapulse modulation and pulse compression to improve range resolution.

40: The system as any of clauses 25-39 describe, where the target acquisition protocol includes frequency data, information about a desired number and position of transceiver nodes, depth data, geological feature data, dielectric property data, waveform data, and cumulative output gain data.

41: The system as any of clauses 25-40 describe, where each of the plurality of transceiver nodes are wirelessly coherent and wirelessly coupled to form a multi-static phased array.

42: The system as any of clauses 25-41 describe, where the plurality of transceiver nodes employs near-field electromagnetic induction during the cohered characterization operation.

43: The system as any of clauses 25-42 describe, where the plurality of transceiver nodes operates as a radar system whenever an electromagnetic echo return is received from the at least one target.

44: The system as any of clauses 25-43 describe, where the at least one target is within a Fresnel zone of at least one arbitrary transceiver node from the plurality of transceiver nodes.

45: The system as any of clauses 25-44 describe, where the processor applies non-linear predistortion methods that use a known electrical permittivity of the earth and a known reference source to account for non-linearities in the deep earth.

46: The system as any of clauses 25-45 describe, where each of the plurality of transceiver nodes includes at least one low frequency solid-state power amplifier that operates within a range of 1 Hz to 1 MHz.

47: The system as any of clauses 25-46 describe, where the at least one solid-state power amplifier transmits a wideband chirp waveform to produce high-resolution profiles of subsurface features.

48: The system as any of clauses 25-47 describe, where the at least one solid-state power amplifier produces a non-continuous chirp waveform across several frequency bands.

49: A non-transitory computer-readable medium storing a set of instructions for deep earth penetrating multi-static ground mapping radar, the set of instructions may include: one or more instructions that, when executed by one or more processors of a device, cause the device to: synchronize data signals received or transmitted by a plurality of transceiver nodes based on status information shared by the plurality of transceiver nodes; and cohere synchronized data signals from the plurality of transceiver nodes to generate a geophysical profile for an area of interest.

50: The non-transitory computer-readable medium as clause 49 describes, further may include: receiving status information for the plurality of transceiver nodes identifying at least one target within the geophysical profile generating a target acquisition protocol based on target data, the status information, and the geophysical profile directing the plurality of transceiver nodes to perform a cohered characterization operation to acquire cohered target data within the area of interest in accordance with the target acquisition protocol, where the plurality of transceiver nodes is configured into a bistatic radar array for the cohered characterization operation; and executing supplemental feature analysis based on the cohered target data and the geophysical profile.

51: The non-transitory computer-readable medium as either of clauses 49 or 50 describe, where generating the target acquisition protocol includes: plotting a location of at least one geological feature within the area of interest analyzing the status information, target data, and the geophysical profile to identify at least one transmitter node and at least one receiver node from the plurality of transceiver nodes; and generating an instruction set for characterizing the at least one target through analysis of geophysical, geological, and structural data with the least one transmitter node and the at least one receiver node.

52: The non-transitory computer-readable medium as any of clauses 49-51 describe, where the at least one receiver node is selected based on an output gain of the at least one transmitter node.

53: The non-transitory computer-readable medium as any of clauses 49-52 describe, where the at least one receiver node is selected based on a desired input gain at the at least one receiver node.

54: The non-transitory computer-readable medium as any of clauses 49-53 describe, where the at least one geological feature includes at least one of hydrocarbon deposits, metal/mineral deposits, ground water reservoirs, geothermal regions, oil and gas traps, stratigraphic unconformity, faults, pinch-outs, facies change, dielectric coefficients, rock structure, and stratigraphy data.

55: The non-transitory computer-readable medium as any of clauses 49-54 describe, where the instruction set for characterizing the at least one target includes output characteristics for at least one adaptive interrogation signal that may vary as the area of interest is scanned during the cohered characterization operation.

56: The non-transitory computer-readable medium as any of clauses 49-55 describe, where the cohered characterization operation includes: outputting, via the at least one transmitter node, the at least one adaptive interrogation signal directed toward the area of interest in accordance with the target acquisition protocol receiving, via the at least one receiver node, at least one reflected signal from the area of interest, where the at least one receiver node is selected based on a position of the at least one receiver node relative to the at least one transmitter node and the area of interest in accordance with the target acquisition protocol; and generating an equalized signal from the at least one reflected signal, where the equalization removes noise from the geophysical profile in accordance with the target acquisition protocol.

57: The non-transitory computer-readable medium as any of clauses 49-56 describe, where the supplemental feature analysis is a geosteering operation that includes: outputting, via the at least one transmitter node, the at least one adaptive interrogation signal directed toward a drill bit within the area of interest receiving, via the at least one receiver node, at least one reflected signal from the drill bit, where the at least one receiver node is selected based on a position of the at least one receiver node relative to the at least one transmitter node and the drill bit; and tuning a frequency of the at least one adaptive interrogation signal to scan an area surrounding the drill bit as the drill bit moves through the area of interest.

58: The non-transitory computer-readable medium as any of clauses 49-57 describe, where the supplemental feature analysis is a geosteering operation that includes determining at least one of the drill bit's pitch, orientation, azimuth, and velocity.

59: The non-transitory computer-readable medium as any of clauses 49-58 describe, where the supplemental feature analysis is a monitoring operation that includes: periodically outputting, via the at least one transmitter node, the at least one adaptive interrogation signal directed toward the area of interest receiving, via the at least one receiver node, at least one periodically reflected signal from the area of interest, where the at least one receiver node is selected based on a position of the at least one receiver node relative to the at least one transmitter node and a time varying relationship to a previous state of the area of interest; and appending current cohered target data to a geological data log.

60: The non-transitory computer-readable medium as any of clauses 49-59 describe, where the monitoring operation includes generating a time-varying representation of the geological data log via the processor.

61: The non-transitory computer-readable medium as any of clauses 49-60 describe, where the plurality of transceiver nodes operates in a range of 1 hrz-200 khz.

62: The non-transitory computer-readable medium as any of clauses 49-61 describe, where the plurality of transceiver nodes is configured into a multi-static radar array.

63: The non-transitory computer-readable medium as any of clauses 49-62 describe, where the processor directs the plurality of transceiver nodes to operate as an adjustable pulse radar array, and where the processor employs intrapulse modulation and pulse compression to improve range resolution.

64: The non-transitory computer-readable medium as any of clauses 49-63 describe, where the target acquisition protocol includes frequency data, information about a desired number and position of transceiver nodes, depth data, geological feature data, dielectric property data, waveform data, and cumulative output gain data.

65: The non-transitory computer-readable medium as any of clauses 49-64 describe, where each of the plurality of transceiver nodes are wirelessly coherent and wirelessly coupled to form a multi-static phased array.

66: The non-transitory computer-readable medium as any of clauses 49-65 describe, where the plurality of transceiver nodes employs near-field electromagnetic induction during the cohered characterization operation.

67: The non-transitory computer-readable medium as any of clauses 49-66 describe, where the plurality of transceiver nodes operates as a radar system whenever an electromagnetic echo return is received from the at least one target.

68: The non-transitory computer-readable medium as any of clauses 49-67 describe, where the at least one target is within a Fresnel zone of at least one arbitrary transceiver node from the plurality of transceiver nodes.

69: The non-transitory computer-readable medium as any of clauses 49-68 describe, where the processor applies non-linear predistortion methods that use a known electrical permittivity of the earth and a known reference source to account for non-linearities in the deep earth.

70: The non-transitory computer-readable medium as any of clauses 49-69 describe, where each of the plurality of transceiver nodes includes at least one low frequency solid-state power amplifier that operates within a range of 1 Hz to 1 MHz.

71: The non-transitory computer-readable medium as any of clauses 49-70 describe, where the at least one solid-state power amplifier transmits a wideband chirp waveform to produce high-resolution profiles of subsurface features.

72: The non-transitory computer-readable medium as any of clauses 49-71 describe, where the at least one solid-state power amplifier produces a non-continuous chirp waveform across several frequency bands.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

What is claimed is:

1. A method for deep earth penetrating multi-static ground mapping radar, comprising:
synchronizing, via a processor, data signals received or transmitted by a plurality of transceiver nodes based on status information shared by the plurality of transceiver nodes; and
cohering, via the processor, synchronized data signals from the plurality of transceiver nodes to generate a geophysical profile for an area of interest.

2. The method of claim 1, further comprising:
receiving, via the processor, status information for the plurality of transceiver nodes;
identifying, via the processor, at least one target within the geophysical profile;
generating, via the processor, a target acquisition protocol based on target data, the status information, and the geophysical profile;
directing, via the processor, the plurality of transceiver nodes to perform a cohered characterization operation to acquire cohered target data within the area of interest in accordance with the target acquisition protocol, wherein the plurality of transceiver nodes is configured into a bistatic radar array for the cohered characterization operation; and
executing, via the processor, supplemental feature analysis based on the cohered target data and the geophysical profile.

3. The method of claim 2, wherein generating the target acquisition protocol includes:
plotting, via the processor, a location of at least one geological feature within the area of interest;
analyzing, via the processor, the status information, target data, and the geophysical profile to identify at least one transmitter node and at least one receiver node from the plurality of transceiver nodes; and
generating, via the processor, an instruction set for characterizing the at least one target through analysis of geophysical, geological, and structural data with the least one transmitter node and the at least one receiver node.

4. The method of claim 3, wherein the at least one receiver node is selected based on an output gain of the at least one transmitter node.

5. The method of claim 3, wherein the at least one receiver node is selected based on a desired input gain at the at least one receiver node.

6. The method of claim 3, wherein the at least one geological feature includes at least one of hydrocarbon deposits, metal/mineral deposits, ground water reservoirs, geothermal regions, oil and gas traps, stratigraphic unconformity, faults, pinch-outs, facies change, dielectric coefficients, rock structure, and stratigraphy data.

7. The method of claim 3, wherein the instruction set for characterizing the at least one target includes output characteristics for at least one adaptive interrogation signal that may vary as the area of interest is scanned during the cohered characterization operation.

8. The method of claim 7, wherein the cohered characterization operation includes:
outputting, via the at least one transmitter node, the at least one adaptive interrogation signal directed toward the area of interest in accordance with the target acquisition protocol;
receiving, via the at least one receiver node, at least one reflected signal from the area of interest, wherein the at least one receiver node is selected based on a position of the at least one receiver node relative to the at least one transmitter node and the area of interest in accordance with the target acquisition protocol; and
generating, via the processor, an equalized signal from the at least one reflected signal, wherein the equalization removes noise from the geophysical profile in accordance with the target acquisition protocol.

9. The method of claim 7, wherein the supplemental feature analysis is a geosteering operation that includes:
outputting, via the at least one transmitter node, the at least one adaptive interrogation signal directed toward a drill bit within the area of interest;
receiving, via the at least one receiver node, at least one reflected signal from the drill bit, wherein the at least one receiver node is selected based on a position of the at least one receiver node relative to the at least one transmitter node and the drill bit; and
tuning, via the processor, a frequency of the at least one adaptive interrogation signal to scan an area surrounding the drill bit as the drill bit moves through the area of interest.

10. The method of claim 9, wherein the supplemental feature analysis is a geosteering operation that includes determining at least one of the drill bit's pitch, orientation, azimuth, and velocity.

11. The method of claim 7, wherein the supplemental feature analysis is a monitoring operation that includes:
periodically outputting, via the at least one transmitter node, the at least one adaptive interrogation signal directed toward the area of interest;
receiving, via the at least one receiver node, at least one periodically reflected signal from the area of interest, wherein the at least one receiver node is selected based on a position of the at least one receiver node relative to the at least one transmitter node and a time varying relationship to a previous state of the area of interest; and
appending, via the processor, current cohered target data to a geological data log.

12. The method of claim 11, wherein the monitoring operation includes generating a time-varying representation of the geological data log via the processor.

13. The method of claim 2, wherein the plurality of transceiver nodes operates in a range of 1 hrz-200 khz.

14. The method of claim 2, wherein the plurality of transceiver nodes is configured into a multi-static radar array.

15. The method of claim 2, wherein the processor directs the plurality of transceiver nodes to operate as an adjustable pulse radar array, and wherein the processor employs intrapulse modulation and pulse compression to improve range resolution.

16. The method of claim 2, wherein the target acquisition protocol includes frequency data, information about a desired number and position of transceiver nodes, depth data, geological feature data, dielectric property data, waveform data, and cumulative output gain data.

17. The method of claim 2, wherein each of the plurality of transceiver nodes are wirelessly coherent and wirelessly coupled to form a multi-static phased array.

18. The method of claim 2, wherein the plurality of transceiver nodes employs near-field electromagnetic induction during the cohered characterization operation.

19. The method of claim 2, wherein the plurality of transceiver nodes operates as a radar system whenever an electromagnetic echo return is received from the at least one target.

20. The method of claim 19, wherein the at least one target is within a Fresnel zone of at least one arbitrary transceiver node from the plurality of transceiver nodes.

21. The method of claim 2, wherein the processor applies non-linear predistortion methods that use a known electrical permittivity of the earth and a known reference source to account for non-linearities in the deep earth.

22. The method of claim 2, wherein each of the plurality of transceiver nodes includes at least one low frequency solid-state power amplifier that operates within a range of 0.1 Hz to 1 MHz.

23. The method of claim 22, wherein the at least one solid-state power amplifier transmits a wideband chirp waveform to produce high-resolution profiles of subsurface features.

24. The method of claim 22, wherein the at least one solid-state power amplifier produces a non-continuous chirp waveform across several frequency bands.

25. A system for deep earth penetrating multi-static ground mapping radar comprising:
one or more processors configured to:
synchronize data signals received or transmitted by a plurality of transceiver nodes based on status information shared by the plurality of transceiver nodes; and
cohere synchronized data signals from the plurality of transceiver nodes to generate a geophysical profile for an area of interest.

26. The system of claim 25, further comprising:
the one or more processors further configured to:
receive status information for the plurality of transceiver nodes;
identify at least one target within the geophysical profile;
generate a target acquisition protocol based on target data, the status information, and the geophysical profile;
direct the plurality of transceiver nodes to perform a cohered characterization operation to acquire cohered target data within the area of interest in accordance with the target acquisition protocol, wherein the plurality of transceiver nodes is configured into a bistatic radar array for the cohered characterization operation; and
execute supplemental feature analysis based on the cohered target data and the geophysical profile.

27. The system of claim 26, wherein generating the target acquisition protocol includes:
the one or more processors further configured to:
plot a location of at least one geological feature within the area of interest;
analyze the status information, target data, and the geophysical profile to identify at least one transmitter node and at least one receiver node from the plurality of transceiver nodes; and
generate an instruction set for characterizing the at least one target through analysis of geophysical, geological, and structural data with the least one transmitter node and the at least one receiver node.

28. The system of claim 27, wherein the at least one receiver node is selected based on an output gain of the at least one transmitter node.

29. The system of claim 27, wherein the at least one receiver node is selected based on a desired input gain at the at least one receiver node.

30. The system of claim 27, wherein the at least one geological feature includes at least one of hydrocarbon deposits, metal/mineral deposits, ground water reservoirs, geothermal regions, oil and gas traps, stratigraphic unconformity, faults, pinch-outs, facies change, dielectric coefficients, rock structure, and stratigraphy data.

31. The system of claim 27, wherein the instruction set for characterizing the at least one target includes output characteristics for at least one adaptive interrogation signal that may vary as the area of interest is scanned during the cohered characterization operation.

32. The system of claim 31, wherein the cohered characterization operation includes:
outputting, via the at least one transmitter node, the at least one adaptive interrogation signal directed toward the area of interest in accordance with the target acquisition protocol;
receiving, via the at least one receiver node, at least one reflected signal from the area of interest, wherein the at least one receiver node is selected based on a position of the at least one receiver node relative to the at least one transmitter node and the area of interest in accordance with the target acquisition protocol; and
generating an equalized signal from the at least one reflected signal, wherein the equalization removes noise from the geophysical profile in accordance with the target acquisition protocol.

33. The system of claim 31, wherein the supplemental feature analysis is a geosteering operation that includes:
outputting, via the at least one transmitter node, the at least one adaptive interrogation signal directed toward a drill bit within the area of interest;
receiving, via the at least one receiver node, at least one reflected signal from the drill bit, wherein the at least one receiver node is selected based on a position of the at least one receiver node relative to the at least one transmitter node and the drill bit; and
tuning a frequency of the at least one adaptive interrogation signal to scan an area surrounding the drill bit as the drill bit moves through the area of interest.

34. The system of claim 33, wherein the supplemental feature analysis is a geosteering operation that includes determining at least one of the drill bit's pitch, orientation, azimuth, and velocity.

35. The system of claim 31, wherein the supplemental feature analysis is a monitoring operation that includes:
periodically outputting, via the at least one transmitter node, the at least one adaptive interrogation signal directed toward the area of interest;
receiving, via the at least one receiver node, at least one periodically reflected signal from the area of interest, wherein the at least one receiver node is selected based on a position of the at least one receiver node relative to the at least one transmitter node and a time varying relationship to a previous state of the area of interest; and
appending current cohered target data to a geological data log.

36. The system of claim 35, wherein the monitoring operation includes generating a time-varying representation of the geological data log via the processor.

37. The system of claim 26, wherein the plurality of transceiver nodes operates in a range of 1 hrz-200 khz.

38. The system of claim 26, wherein the plurality of transceiver nodes is configured into a multi-static radar array.

39. The system of claim 26, wherein the processor directs the plurality of transceiver nodes to operate as an adjustable pulse radar array, and wherein the processor employs intrapulse modulation and pulse compression to improve range resolution.

40. The system of claim 26, wherein the target acquisition protocol includes frequency data, information about a desired number and position of transceiver nodes, depth data, geological feature data, dielectric property data, waveform data, and cumulative output gain data.

41. The system of claim 26, wherein each of the plurality of transceiver nodes are wirelessly coherent and wirelessly coupled to form a multi-static phased array.

42. The system of claim 26, wherein the plurality of transceiver nodes employs near-field electromagnetic induction during the cohered characterization operation.

43. The system of claim 26, wherein the plurality of transceiver nodes operates as a radar system whenever an electromagnetic echo return is received from the at least one target.

44. The system of claim 43, wherein the at least one target is within a Fresnel zone of at least one arbitrary transceiver node from the plurality of transceiver nodes.

45. The system of claim 26, wherein the processor applies non-linear predistortion methods that use a known electrical permittivity of the earth and a known reference source to account for non-linearities in the deep earth.

46. The system of claim 26, wherein each of the plurality of transceiver nodes includes at least one low frequency solid-state power amplifier that operates within a range of 0.1 Hz to 1 MHz.

47. The system of claim 46, wherein the at least one solid-state power amplifier transmits a wideband chirp waveform to produce high-resolution profiles of subsurface features.

48. The system of claim 46, wherein the at least one solid-state power amplifier produces a non-continuous chirp waveform across several frequency bands.

49. A non-transitory computer-readable medium storing a set of instructions for deep earth penetrating multi-static ground mapping radar, the set of instructions comprising:
one or more instructions that, when executed by one or more processors of a device, cause the device to:
synchronize data signals received or transmitted by a plurality of transceiver nodes based on status information shared by the plurality of transceiver nodes; and
cohere synchronized data signals from the plurality of transceiver nodes to generate a geophysical profile for an area of interest.

50. The non-transitory computer-readable medium of claim 49, further comprising:
receiving status information for the plurality of transceiver nodes;
identifying at least one target within the geophysical profile;
generating a target acquisition protocol based on target data, the status information, and the geophysical profile;
directing the plurality of transceiver nodes to perform a cohered characterization operation to acquire cohered target data within the area of interest in accordance with the target acquisition protocol, wherein the plurality of transceiver nodes is configured into a bistatic radar array for the cohered characterization operation; and
executing supplemental feature analysis based on the cohered target data and the geophysical profile.

51. The non-transitory computer-readable medium of claim 50, wherein generating the target acquisition protocol includes:
plotting a location of at least one geological feature within the area of interest;
analyzing the status information, target data, and the geophysical profile to identify at least one transmitter node and at least one receiver node from the plurality of transceiver nodes; and
generating an instruction set for characterizing the at least one target through analysis of geophysical, geological, and structural data with the least one transmitter node and the at least one receiver node.

52. The non-transitory computer-readable medium of claim 51, wherein the at least one receiver node is selected based on an output gain of the at least one transmitter node.

53. The non-transitory computer-readable medium of claim 51, wherein the at least one receiver node is selected based on a desired input gain at the at least one receiver node.

54. The non-transitory computer-readable medium of claim 51, wherein the at least one geological feature includes at least one of hydrocarbon deposits, metal/mineral deposits, ground water reservoirs, geothermal regions, oil and gas traps, stratigraphic unconformity, faults, pinch-outs, facies change, dielectric coefficients, rock structure, and stratigraphy data.

55. The non-transitory computer-readable medium of claim 51, wherein the instruction set for characterizing the at least one target includes output characteristics for at least one adaptive interrogation signal that may vary as the area of interest is scanned during the cohered characterization operation.

56. The non-transitory computer-readable medium of claim 55, wherein the cohered characterization operation includes:
outputting, via the at least one transmitter node, the at least one adaptive interrogation signal directed toward the area of interest in accordance with the target acquisition protocol;
receiving, via the at least one receiver node, at least one reflected signal from the area of interest, wherein the at least one receiver node is selected based on a position of the at least one receiver node relative to the at least one transmitter node and the area of interest in accordance with the target acquisition protocol; and
generating an equalized signal from the at least one reflected signal, wherein the equalization removes noise from the geophysical profile in accordance with the target acquisition protocol.

57. The non-transitory computer-readable medium of claim 55, wherein the supplemental feature analysis is a geosteering operation that includes:
outputting, via the at least one transmitter node, the at least one adaptive interrogation signal directed toward a drill bit within the area of interest;
receiving, via the at least one receiver node, at least one reflected signal from the drill bit, wherein the at least one receiver node is selected based on a position of the at least one receiver node relative to the at least one transmitter node and the drill bit; and
tuning a frequency of the at least one adaptive interrogation signal to scan an area surrounding the drill bit as the drill bit moves through the area of interest.

58. The non-transitory computer-readable medium of claim 57, wherein the supplemental feature analysis is a geosteering operation that includes determining at least one of the drill bit's pitch, orientation, azimuth, and velocity.

59. The non-transitory computer-readable medium of claim 55, wherein the supplemental feature analysis is a monitoring operation that includes:
periodically outputting, via the at least one transmitter node, the at least one adaptive interrogation signal directed toward the area of interest;
receiving, via the at least one receiver node, at least one periodically reflected signal from the area of interest, wherein the at least one receiver node is selected based on a position of the at least one receiver node relative to the at least one transmitter node and a time varying relationship to a previous state of the area of interest; and
appending current cohered target data to a geological data log.

60. The non-transitory computer-readable medium of claim 59, wherein the monitoring operation includes generating a time-varying representation of the geological data log via the processor.

61. The non-transitory computer-readable medium of claim 50, wherein the plurality of transceiver nodes operates in a range of 1 hrz-200 khz.

62. The non-transitory computer-readable medium of claim 50, wherein the plurality of transceiver nodes is configured into a multi-static radar array.

63. The non-transitory computer-readable medium of claim 50, wherein the processor directs the plurality of transceiver nodes to operate as an adjustable pulse radar array, and wherein the processor employs intrapulse modulation and pulse compression to improve range resolution.

64. The non-transitory computer-readable medium of claim 50, wherein the target acquisition protocol includes frequency data, information about a desired number and position of transceiver nodes, depth data, geological feature data, dielectric property data, waveform data, and cumulative output gain data.

65. The non-transitory computer-readable medium of claim 50, wherein each of the plurality of transceiver nodes are wirelessly coherent and wirelessly coupled to form a multi-static phased array.

66. The non-transitory computer-readable medium of claim 50, wherein the plurality of transceiver nodes employs near-field electromagnetic induction during the cohered characterization operation.

67. The non-transitory computer-readable medium of claim 50, wherein the plurality of transceiver nodes operates as a radar system whenever an electromagnetic echo return is received from the at least one target.

68. The non-transitory computer-readable medium of claim 67, wherein the at least one target is within a Fresnel zone of at least one arbitrary transceiver node from the plurality of transceiver nodes.

69. The non-transitory computer-readable medium of claim 50, wherein the processor applies non-linear predistortion methods that use a known electrical permittivity of the earth and a known reference source to account for non-linearities in the deep earth.

70. The non-transitory computer-readable medium of claim 50, wherein each of the plurality of transceiver nodes includes at least one low frequency solid-state power amplifier that operates within a range of 0.1 Hz to 1 MHz.

71. The non-transitory computer-readable medium of claim 70, wherein the at least one solid-state power amplifier transmits a wideband chirp waveform to produce high-resolution profiles of subsurface features.

72. The non-transitory computer-readable medium of claim 70, wherein the at least one solid-state power amplifier produces a non-continuous chirp waveform across several frequency bands.
